(19) United States
(12) Patent Application Publication
(10) Pub. No.: US 2024/0312656 A1
(43) Pub. Date: Sep. 19, 2024

(54) SYSTEMS AND METHODS FOR ELECTROCHEMICAL EXTRACTION OF REDUCED FISSION PRODUCTS FROM IRRADIATED MOLTEN SALT COMPOSITIONS

(71) Applicant: ABILENE CHRISTIAN UNIVERSITY, Abilene, TX (US)

(72) Inventors: Kim Pamplin, Abilene, TX (US); Diego Zometa, Abilene, TX (US)

(21) Appl. No.: 18/604,025

(22) Filed: Mar. 13, 2024

Related U.S. Application Data
(60) Provisional application No. 63/490,725, filed on Mar. 16, 2023.

(51) Int. Cl. G21C 19/31; G21C 3/54

(52) U.S. Cl. CPC G21C 19/31; G21C 3/54

(57) ABSTRACT

Fission of uranium-235 produces a wide range of fission products. Of particular importance is the production of molybdenum-99 due to its uses in the medical field. Fission products can be extracted from a molten salt reactor through electrochemical deposition by utilizing an electrode submerged in the flow of irradiated molten salt. However, this is likely to disrupt the redox of the irradiated molten fuel leading to harmful corrosion of the reactor. The present invention utilizes three electrode sets to capture fission products from irradiated molten salt of a molten salt reactor, monitor the redox behavior of the irradiated molten salt, and maintaining the balance of uranium ions to avoid harmful corrosion to the reactor's core.

### RELATED APPLICATION

The present application relates and claims priority to U.S. Provisional Application No. 63/490,725, filed on Mar. 16, 2023, which is hereby incorporated by reference in its entirety.

### TECHNICAL FIELD

The present application relates generally to systems and methods for electrochemical extraction of reduced fission products, including molybdenum-99 from irradiated, fueled molten salt compositions. The systems are in fluid communication with a molten salt reactor core. The systems and methods also maintain the balance of uranium(IV) and uranium(III) in the proper range to prevent or minimize the formation of uranium carbides.

### BACKGROUND

The fission of uranium-235 (U-235) produces a spectrum of fission products, including molybdenum-99 (Mo-99), iodine-131 (I-131) and xenon-133 (Xe-133). The decay product of Mo-99, technetium-99m (Tc-99m), is used in at least two-thirds of all diagnostic medical isotope procedures. Tc-99m is used for detection of disease and for the study of organ structure and function. Tc-99m has a half-life of about 6 hours and emits 140 keV photons when it decays to Tc-99, a radioactive isotope with an approximately 214,000-year half-life. This photon energy is useful for detection by scintillation instruments such as gamma cameras, and the data collected by the cameras are analyzed to produce structural and functional images.

Mo-99 is typically produced in uranium-bearing targets by irradiating them with thermal neutrons. Some of the U-235 nuclei absorb these neutrons, which can cause them to fission. The fission of U-235 nucleus produces two but sometimes three lower-mass nuclei referred to as fission fragments. Approximately 6 percent of these fission fragments are Mo-99 atoms. Nuclear reactors provide an efficient source of thermal neutrons for Mo-99 production.

A molten salt reactor (MSR) is a class of nuclear fission reactors that contain either a liquid salt coolant, a liquid salt coolant-fuel mixture, or a two-fluid blanket and fuel arrangement. MSRs can operate in the fast, thermal or epithermal neutron spectra, and can be set up to breed or simply burn fuel. Thermal reactor designs are typically moderated using graphite.

The liquid (or molten) salts must be able to dissolve the fuel and blanket and allow for easy chemical separation of fission products after irradiation. They must also be chosen to maximize performance and safety. Typical salts can be made of fluorine, chlorine, lithium, sodium, potassium, beryllium, rubidium, and zirconium compounds. Fluoride-based salts are a typical choice for thermal spectrum reactor designs, as they absorb fewer neutrons and are better moderators than other halides.

The nuclear industry gained familiarity with molten salt reactors following the June 1965 startup of the Oak Ridge National Laboratory (ORNL) Molten Salt Reactor Experiment (MSRE). The ORNL MSRE design incorporated a one-region reactor with graphite moderator and circulating fuel. The moderator consisted of vertical stringers of graphite, which formed a cylindrical core within a reactor vessel. The fuel passed downward in an annulus between the graphite cylinder and the core barrel. It then flowed upward in channels formed between the stringers, out the top to a pump, through a heat exchanger, and back to the core. Exiting at nearly 663° C. the fuel entered a sump-type fuel pump and was discharged through the shell side of the heat exchanger back to the core inlet. The MSRE operated for a period of four years.

There remains a need for systems and methods for the extraction of Mo-99 and other fission products from MSRs.

### SUMMARY OF THE INVENTION

Aspects of this disclosure are directed to systems and methods for extraction of reduced fission products, such as Mo-99, from fueled salt compositions after reaction in a molten salt reactor core.

In one example, a system for extraction of reduced fission products from an irradiated fueled molten salt composition comprises:
(i) an irradiated fueled molten salt composition comprises one or more types of molten salts, one or more types of uranium fluoride compounds and fission products in fluid communication with the reactor core of a molten salt reactor;
(ii) a conduit, which comprises an inlet for entry of the fueled molten salt composition after reaction in the reactor core of the molten salt reactor, an outlet for return of the fueled molten salt composition to the reactor core of the molten salt reactor, two openings in the wall of the conduit at which counter electrode chambers are attached, and optionally, one or more additional opening sealed with a cover for removal of one or more working electrodes;
(iii) a first counter electrode chamber, which protrudes from, or is attached to, the conduit and forms a continuous interior with the conduit;
(iv) a first porous membrane, which forms a cross-sectional permeable barrier between the interior of the first counter electrode chamber and the interior of the conduit;
(v) a first set of electrodes, comprising a first reference electrode and a first working electrode, both in the interior of the conduit, and a first counter electrode in the interior of the first counter electrode chamber and separated from the interior of the conduit by the first porous membrane, wherein the first set of electrodes is in communication with a first control system (e.g., a first potentiostat), which is external to the conduit;
(vi) a second counter electrode chamber, which protrudes from, or is attached to, the conduit and forms a continuous interior with the conduit;
(vii) a second porous membrane, which forms a cross-sectional permeable barrier between the interior of the second counter electrode chamber and the interior of the conduit;
(viii) a second set of electrodes positioned downstream from the first set of electrodes, comprising a second reference electrode and a second working electrode, both in the interior of the conduit, and a second counter electrode in the interior of the second counter electrode chamber and separated from the interior of the conduit by the second porous membrane, wherein the second set of electrodes is in communication with a second control system (e.g., a second potentiostat), which is external to the conduit;
(ix) a third set of electrodes positioned downstream from the second set of electrodes, comprising a third reference electrode and a third working electrode, both in the interior of the conduit, wherein the third set of electrodes is in communication with a meter to measure the uranium ions (e.g. uranium(IV)/(III) balance) in the fueled molten salt composition,
wherein the meter is external to the conduit and is in communication with the second control system; wherein the irradiated fueled molten salt composition exiting the reactor core is at a temperature in the range of about 600° C. to about 700° C.;
wherein the first and second counter electrode chambers each contain an unfueled molten salt composition;
wherein all of the electrodes are in contact with the irradiated fueled molten salt composition or the unfueled molten salt compositions;
wherein the control systems are configured to apply an electric potential to the electrodes to effect reduction of fission products at the first working electrode, deposition of reduced fission products on the first working electrode, and oxidation of uranium(III) at the second working electrode; and
wherein the first working electrode can be removed from the system to facilitate collection of the deposited reduced fission products.

In another aspect, a method for extraction of reduced fission products from an irradiated fueled molten salt composition comprises:
(a) contacting an irradiated fueled molten salt composition with a first working electrode to reduce fission products which are deposited on the first working electrode;
(b) contacting the irradiated fueled molten salt composition with a second working electrode, after contact with the first working electrode, to oxidize uranium(III) to uranium(IV) compounds contained in the irradiated fueled molten salt composition;
(c) contacting the irradiated fueled molten salt composition with a third working electrode and measuring the uranium(IV)/(III) ratio of the irradiated fueled molten salt composition with a meter, after contact with the second working electrode; and
(d) collecting the reduced fission products deposited on the first working electrode;
wherein the irradiated fueled molten salt composition comprises one or more types of molten salts, one or more types of uranium fluoride compounds and fission products in fluid communication with the reactor core of a molten salt reactor.

In one example, a system for capture of fission products from irradiated fueled molten salt of a molten salt reactor system is disclosed. The system includes a first electrode circuit including a first working electrode. The first electrode circuit is operable to capture the fission products from the irradiated fueled molten salt by electrochemical deposition of the fission products onto the first working electrode. The system further includes a second electrode circuit including a second working electrode and a potentiostat. The second electrode circuit is operable to adjust a ratio of uranium(IV) to uranium(III) of the irradiated fueled molten salt by oxidation of uranium(III) by the second working electrode. The system further includes a third electrode circuit including a meter electrically coupled with the potentiostat. The third electrode circuit is operable to measure an electric potential of the irradiated fueled molten salt. The potentiostat is operable to adjust an electric current provided to the second working electrode upon the meter reading that the electric potential of the irradiated fueled molten salt has reached a predetermined threshold. The first electrode circuit, second electrode circuit, and third electrode circuit are housed in a conduit of the molten salt reactor system.

The conduit may be configured to facilitate flow of the irradiated fueled molten salt of the molten salt reactor system to the first working electrode, the second working electrode, and the third electrode circuit.

The first electrode circuit may include a first counter electrode enclosed in a first counter electrode chamber, which protrudes from and/or is attached to the conduit, such that the first counter electrode chamber is along a different fluid path than a fluid path of the conduit.

The first counter electrode chamber may be separate from an interior of the conduit by a first porous membrane.

The first counter electrode chamber may contain unfueled molten salt.

The first porous membrane may be operable to provide an electrically permeable barrier between the irradiated fueled molten salt of the conduit and the unfueled molten salt of the first counter electrode chamber, and the electrically permeable barrier may be operable to minimize and/or prevent mixing of the irradiated fueled molten salt and the unfueled molten salt while allowing passage of current.

The first porous membrane may include a plurality of pores with a size of about 0.1 nanometer to about 1 millimeter.

The first electrode circuit, second electrode circuit, and third electrode circuit may be located within the conduit such that the third electrode circuit is positioned downstream of the second electrode circuit and the second electrode circuit is positioned downstream of the first electrode circuit.

The fission products may include molybdenum-99.

The first working electrode may be removable from the first electrode circuit.

The conduit may include an inlet in fluid communication with a core of the molten salt reactor, such that the first electrode circuit is positioned proximal to an outlet of a molten salt reactor vessel of the molten salt reactor system.

The conduit may include at least one bypass valve and at least one bypass pipe operable to divert the flow of irradiated fueled molten salt to the first working electrode in the at least one bypass pipe.

In another example the system includes a fuel salt system configured to circulate an irradiated fueled molten salt through a molten salt loop. The molten salt loop includes a reactor vessel. The system further includes an extraction system fluidly coupled to the reactor vessel along the molten salt loop, the extraction system includes a first electrode circuit including a first working electrode. The first electrode circuit is operable to capture the fission products from the irradiated fueled molten salt by electrochemical deposition of the fission products onto the first working electrode. The extraction system further includes a second electrode circuit including a second working electrode and a potentiostat. The second electrode circuit is operable to adjust a ratio of uranium(IV) to uranium(III) of the irradiated fueled molten salt by oxidation of uranium(III) by the second working electrode. The extraction system further includes a third electrode circuit including a meter electrically coupled with the potentiostat. The third electrode circuit is operable to measure an electric potential of the irradiated fueled molten salt. The potentiostat is operable to adjust an electric current provided to the second working electrode upon the meter of the third electrode circuit reading that the electric potential of the irradiated fueled molten salt has reached a predetermined threshold. The first electrode circuit, second electrode circuit, and third electrode circuit are housed in a conduit of the molten salt loop.

This example system may further include a reactor pump fluidly coupled to the extraction system operable to facilitate the circulation of the irradiated fueled molten salt to the extraction system.

This example system may further include a heat exchanger positioned within the molten salt loop, such that the heat exchanger is downstream of the reactor pump, the reactor pumped is downstream of the extraction system, and the extraction system is downstream of the reactor vessel.

The second electrode circuit, in this example system, may include a second counter electrode encased in a second counter electrode chamber, which protrudes from and/or is attached to the conduit. The second counter electrode chamber may contain unfueled molten salt and the second counter electrode chamber may be separated from an interior of the conduit by a second porous membrane. The second porous membrane may be operable to provide an electrically permeable barrier between the irradiated molten salt and the unfueled molten salt.

The first counter electrode chamber and the second counter electrode chamber may be fluidly connected by a channel.

The first working electrode may be removable from the first electrode circuit.

In another example a method for capturing fission products from irradiated fueled molten salt of a molten salt reactor is disclosed. In one example the method includes capturing the fission products from the irradiated fueled molten salt through electrochemical deposition of the fission products onto a first working electrode. Then, adjusting a ratio of uranium(IV) to uranium(III) of the irradiated fueled molten salt by oxidizing uranium(III) by a second working electrode. Then, measuring an electric potential of the irradiated fueled molten salt. Followed by adjusting the electric current provided to the second working electrode upon the electric potential of the irradiated fueled molten salt reaching a predetermine threshold. Finally, facilitating flow of the irradiated fueled molten salt of the molten salt reactor to the first working electrode and the second working electrode by a conduit configured to house the first working electrode and the second working electrode.

In this example, adjusting the electric current provided to the second working electrode may include shutting off the electric current provided to the second working electrode upon the electric potential being above an upper range of the predetermined threshold.

This fission products may include molybdenum.

This example method may further include isolating the first working electrode from the flow of the irradiated fueled molten salt through at least one bypass of the conduit.

This example method may further include comprising removing the first working electrode from the conduit.

### BRIEF DESCRIPTION OF THE FIGURES

FIG. 1 illustrates a schematic representation of an example molten salt reactor system according to one embodiment of the present invention.

FIG. 2 illustrates an example reactor thermal management system according to one embodiment of the present invention.

FIG. 3A illustrates a molten salt reactor system including an electrochemical extraction system according to one embodiment of the present invention.

FIG. 3B illustrates an electrochemical extraction system according to one embodiment of the present invention.

FIG. 3C illustrates an isometric view of an electrochemical extraction system according to one embodiment of the present invention.

FIG. 3D illustrates an exploded view of an electrochemical extraction system according to one embodiment of the present invention.

FIG. 4 illustrates an exemplary electrochemical extraction system according to one embodiment of the present invention.

FIG. 5 illustrates an exemplary three-electrode circuit according to one embodiment of the present invention.

FIG. 6A illustrates an isometric view of a working electrode system according to one embodiment of the present invention.

FIG. 6B illustrates a cross-sectional view of the working electrode of FIG. 6A, taken along line 6B-6B of FIG. 6A.

FIG. 6C illustrates isometric view of a working electrode system according to one embodiment of the present invention.

FIG. 6D illustrates a cross-sectional view of the working electrode of FIG. 6C, taken along line 6D-6D of FIG. 6C.

FIG. 6E illustrates an isometric view of a working electrode system according to one embodiment of the present invention.

FIG. 6F illustrates a cross-sectional view of the working electrode of FIG. 6E, taken along line 6F-6F of FIG. 6E.

FIG. 6G illustrates an isometric view of a working electrode system according to one embodiment of the present invention.

FIG. 6H illustrates a cross-sectional view of the working electrode of FIG. 6G, taken along line 6H-6H of FIG. 6G.

FIG. 6I illustrates an isometric view of a working electrode system according to one embodiment of the present invention.

FIG. 6J illustrates a cross-sectional view of the working electrode of FIG. 6I, taken along line 6J-6J of FIG. 6I.

FIG. 7 illustrates an orthogonal view of a mesh working electrode according to one embodiment of the present invention.

FIG. 8 illustrates a flow diagram for a feedback loop according to one embodiment of the present invention.

FIG. 9 illustrates an exemplary electric potential range for a feedback loop according to one embodiment of the present invention.

FIG. 10 illustrates a flow diagram of a method for capturing fission products from irradiated fueled molten salt of a molten salt reactor.

FIG. 11 illustrates a functional block diagram of a system including an analysis device.

### DEFINITIONS

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology can be applied, as long as that definition does not conflict with any other disclosure or definition applied herein or render indefinite or non-enabled any claim to which that definition is applied. To the extent that any definition or usage provided by any document incorporated herein by reference conflicts with the definition or usage provided herein, the definition or usage provided herein controls.

While compositions and methods are described in terms of “comprising” various components or steps, the compositions and methods can also “consist essentially of” or “consist of” the various components or steps, unless stated otherwise.

The terms “a,” “an,” and “the” are intended to include plural alternatives, e.g., at least one. The terms “including”, “with”, and “having”, as used herein, are defined as comprising (i.e., open language), unless specified otherwise.

Various numerical ranges are disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. For example, all numerical end points of ranges disclosed herein are approximate, unless excluded by proviso.

Values or ranges may be expressed herein as “about”, from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means±20% of the stated value, ±15% of the stated value, ±10% of the stated value, ±5% of the stated value, ±3% of the stated value, or 1% of the stated value.

The term “fission” refers to the process of radioactive decay in which unstable atoms split into fission fragments or products. Neutrons continue the fission process by impacting other unstable atoms.

The term “electrode” refers to an electrical conductor used to make contact with a nonmetallic part of a circuit.

The term “anode” refers to an electrode through which the conventional current enters from the electrical circuit of an electrochemical cell into the non-metallic cell. The electrons flow away from the anode and the conventional current towards it.

The term “cathode” refers to an electrode through which the electrons flow from the electrical circuit into the non-metallic part of the electrochemical cell. At the cathode, the reduction reaction takes place with the electrons arriving from the wire connected to the cathode and are absorbed by the oxidizing agent.

The term “working electrode” refers to the electrode which makes contact with the analyte, applies the desired potential in a controlled way and facilitates the transfer of charge to and from the analyte.

The term “reference electrode” refers to an electrode having a known potential with which to gauge the potential of the working electrode. The reference electrode acts as reference in measuring and controlling the working electrode's potential and does not pass current.

The term “counter electrode” refers to an electrode that balances the charge added or removed by the working electrode. The counter electrode passes all the current needed to balance the current observed at the working electrode. The counter electrode makes a connection to the electrolyte so that a current can be applied to the working electrode.

The term “potentiostat” refers to the electronic hardware required to control, for example, a three-electrode cell (e.g., set). A potentiostat measures the potential between the working and reference electrodes whilst the current is measured between the working and counter electrodes. The potential of the working electrode is adjusted by adjusting the current at a counter electrode.

The term, “downstream” as referred herein, describes the components relative positions within the conduit, such that fueled molten salt contacts certain components prior to contacting others. A second component is considered “downstream” of a first component where the flow of molten salt contacts the first component prior to flowing to the second component. Given that the present invention utilizes molten salt (i.e., salt in a liquid or semi-liquid form) one of ordinary skill in the art will appreciate the meaning of downstream and upstream.

### DESCRIPTION OF THE INVENTION

Systems and methods for the extraction of reduced fission products from an irradiated fueled molten salt compositions are disclosed herein. Uranium atoms, e.g., U-235, in the fueled molten salt composition may undergo fission in the reactor core of a molten salt reactor (MSR) to yield fission products which may be present in the irradiated fueled molten salt composition. The fueled molten salt may be carried through the MSR system by a conduit or series of tubing or piping connecting the components of the MSR system together (e.g., reactor vessel, heat exchanger, reactor access vessel, fuel pump, drain tank, etc.). It is advantageous to remove these fission products from the fueled molten salt for a variety of reasons. One reason is to avoid the continual buildup of fission products, which may cause damage to the reactor of the MSR or inhibit the fission rate of the MSR system.

Another reason is for the collection of valuable fission products. For example, molybdenum-99 (often referred to as Mo-99) is a unique isotope of molybdenum that gives birth to technetium-99m (Tc-99m) through beta decay. Tc-99m is used in tens of millions of medical diagnostic procedures annually. Conventional MSR systems allow for the buildup of fission products in the fueled molten salt until the molten salt is removed from the MSR system. However, this is inefficient for a variety of reasons, such as requiring a shut down or slowdown of nuclear fission and the loss of fission products during extraction.

To mitigate these and other challenges, as well as, to address the inefficiencies present in the prior art, the present disclosure provides for an extraction system, adaptable to conventional MSR systems, for the removal and collection of fission products from the fueled molten salt while the MSR system is at full power (or at any power level), such that fission product buildup may be lessened and valuable fission products not wasted. The extraction system of the present invention utilizes a plurality of electrode circuits or “sets” to capture fission products and mitigate imbalance in the redox of the molten salt that may be caused by the fission-capturing circuits. The plurality of electrode circuits may be positioned within a conduit loop of an MSR system. A conduit loop may be used to facilitate flow of the fueled molten salt to the plurality of electrode sets, such that they can make contact with the fueled molten salt.

The extraction system utilizes electrochemical deposition in order to capture fission products found in the fueled molten salt, which may be facilitated by the plurality of electrode sets. The plurality of electrode sets may utilize a three electrode system which may include at least one working electrode (i.e., operable to facilitate physical deposition), at least one counter electrode (i.e., operable to complete the circuit to the working electrode and maintain a constant interfacial potential), and at least one reference electrode (i.e., operable as a reference to measure and control the potential of the working electrode) in order to encourage electrochemical deposition.

Introduction of a charged electrode into the fueled molten salt is likely to cause an imbalance in the redox of the fueled molten salt. Therefore, at least one additional electrode circuit is included to mitigate this imbalance. For example, the imbalance may be caused by the reduction of uranium(IV) ions into uranium(III) ions upon contact with a charged electrode. This can cause the formation of uranium carbides that promote a reaction with the graphite moderator of the MSR which may cause damage to the reactor of the MSR system. Thus, warranting the second electrode circuit.

An additional electrode circuit (i.e., the third) may be included to aid the second electrode circuit. The third electrode set may be operable to measure the electric potential of the fueled molten salt, which provides an indirect measurement of the uranium(IV) to uranium(III) ratio. This measurement may be provided to a computer system or potentiostat of the second electrode set in order to properly rebalance the uranium ion balance of the fueled molten salt. The extraction system may further include an automatic feedback mechanism or loop, which continually monitors the electric potential of the fueled molten salt and provide proper correction mechanism to cause the electric potential to fall within a desirable range.

The present invention utilizes an electrically charged working electrode to attract fission products and upon contact with such fission products, promote deposition thereto. The first working electrode may be configured to create a negatively charge surface upon which positively charged particles (i.e., fission products) can adhere to. Upon contact with the first working electrode, the positively charges particles can be reduced and deposited onto the first working electrode.

While the discussion that follows primarily describes Mo-99 ions as the fission products being captured, one of ordinary skill in the art will appreciate that the systems described herein are operable to attract and collect any positively charged metal fission product ion. Therefore, when describing a mechanism for the capture of Mo-99, it should not be construed as limiting but as an example of one of many fission products that can be captured by the present invention. For further clarity, Mo-99 is used as an example fission product for capture due to its high value in the medical field.

The extraction system may generally comprise at least three sets of electrodes (sometimes referred to as “electrode circuits”). The first electrode set may comprise a first working electrode, a first reference electrode and/or a first counter electrode. The first working electrode and first reference electrode may be in contact with, or immersed in, the fueled molten salt composition while the first counter electrode may be in contact with, or immersed in, an unfueled molten salt composition. This configuration enables the first working electrode to make contact with the fueled molten salt to facilitate capture of fission products while the first counter electrode completes the circuit without reacting any of the components of the fueled molten salt. The first working electrode may be a cathode and the first counter electrode may be an anode. The first counter electrode may be operable to provided electrical current to the first working electrode. The first working electrode and first counter electrode may be separated by a porous membrane to slow or eliminate the mixing of the products of the electrolysis. The porous membrane may be configured to allow electric communication between the first working electrode and the first counter electrode while preventing the first counter from interfering with the redox of the fueled molten salt. Fission products may be reduced at the cathode. For example, ⁹⁹Moⁿ⁺ (i.e., molybdenum cation) is reduced to ⁹⁹Mo⁰, which is deposited on the cathode (i.e., the first working electrode). Similarly, any metal cation fission product may be reduced to a neutrally charged atom, upon contact with the cathode, and deposited on the cathode.

However, inclusion of the first electrode set may also reduce other components of the fueled molten salt. For example, uranium(IV), present in the fueled molten salt composition, can be reduced to form uranium(III) at the cathode. The buildup of uranium(III) in the fueled molten salt causes an imbalance in the ratio of uranium(IV) to uranium(III). This imbalance may promote the creation of uranium carbides which may corrode the reactor of the MSR system. This is an undesired consequence of the first working electrode and warrants the second and third electrode circuit.

The second set of electrodes may be included and configured to counteract the undesirable results of including the first set of electrodes into the system. The need for the second electrode set is compounded when uranium(III) ions, potentially caused by uranium(IV) ions contacting the first electrode set, contact and react with fission products (e.g., Moⁿ⁺ ions) which may result in reduction of the fission products (i.e., Moⁿ⁺ ions being reduced to Mo⁰ atoms) and oxidation of uranium(III) into uranium(IV), thus avoiding capture of the fission products and reducing the yield. For clarity, when Mo-99 cations contact uranium(III) ions, they may be reduced, becoming solid metallic particles and avoiding capture. Stated otherwise, if the fission products are reduced prior to making contact with the first working electrode, they cannot be electrochemically deposited onto the electrode. This is an undesirable consequence of including the first electrode set. Therefore, the second electrode set may be included and configured to offset this undesired consequence by providing a positively charged electrode to oxidize the uranium(III) into uranium(IV) so there are less uranium(III) ions to interrupt fission product capture.

The extraction system may include a second set of electrodes. The second set of electrodes may include similar components to that of the first set of electrodes (i.e., working, counter, and reference electrodes). The second set of electrodes may be included to alter the balance of uranium(IV) and uranium(III) by oxidation of uranium(III) to form uranium(IV). The second electrode set may be included to counteract the undesired consequence of the first electrode set. The second electrode set may be positioned downstream from the first electrode set. Similar to the first electrode set, the second working electrode and second reference electrode may be contact with, or immersed in, the fueled molten salt composition while the second counter electrode may be in contact with, or immersed in, an unfueled molten salt composition. The second electrode set may be configured in such a way to encourage the opposite reaction as that occurring at the first electrode set to counteract the undesirable side effects of the first electrode set. For example, where the first working electrode is a cathode, the second working electrode may be an anode and the second counter electrode may be a cathode. The second working electrode and second counter electrode may also be separated by a porous membrane to slow or eliminate the mixing of the products of the electrolysis.

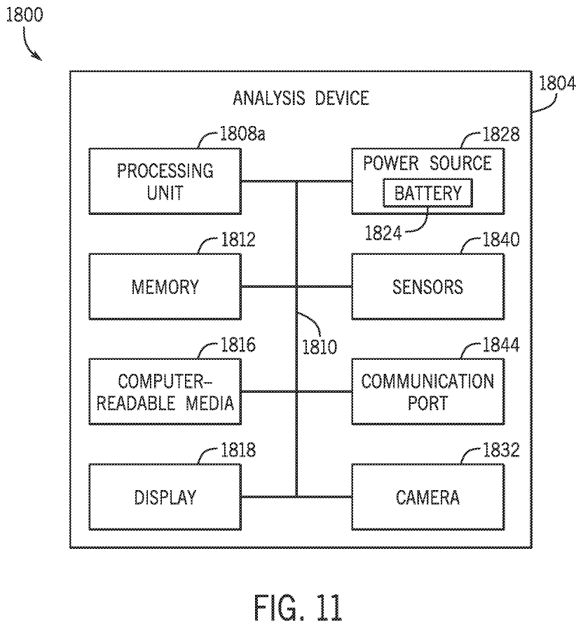

Each electrode set may further include a control system or potentiostat, operable to control the voltage between the counter electrode and the working electrode. The control system may be the potentiostat 1800 and operable to facilitate the functions described herein and in reference to FIG. 11.

The extraction system may include a third set of electrodes to aid the second set of electrodes by providing a measurement of the electric potential of the fueled molten salt. As previously stated, the electric potential of the fueled molten salt provides an indirect measurement of the uranium(IV) to uranium(III) ratio of the molten salt. The third set of electrodes may be configured to measure the electric potential of the fueled molten salt and may be configured to not react with the fueled molten salt. To this end, the third set of electrodes may only include a working electrode and reference electrode and exclude a counter electrode.

While the second electrode set may be included in the extraction system to rebalance the ratio of uranium(IV) to uranium(III) present in the fueled molten salt, the MSR may not require that the second electrode set react with the fueled molten salt continuously. While it may be desirable to provide continuous current to the first working electrode, in order to continuously capture fission products, it may not be desirable to provide continuous current to the second working electrode. This is because the uranium(IV) to uranium(III) ratio may be balanced (or at least in a desired range) at any particular time. To this end, a third electrode set may be included to provide the necessary feedback to the second electrode set needed to determine if more uranium(IV) needs to be produced or not.

The third electrode set may include and/or be in communication with a meter. The meter may be configured to provide the electric potential measurements (i.e., feedback) to the control system (or potentiostat) of the second set of electrodes. Feedback from the third set of electrodes may be used by the potentiostat of the second electrode set in determining how to adjust the balance of uranium(IV) and uranium(III) in the fueled molten salt composition through adjustment of the application of the electric current to the second working electrode. Stated otherwise, the third set of electrodes provides feedback of the second electrode set's impact on the redox of the fueled molten salt, such that the second potentiostat is provided the information needed to assess whether more uranium(IV) needs to be produced or not. The potentiostat of the second electrode set may read the meter of the third electrode set, assess whether the uranium(IV) to uranium(III) is at the proper ratio (or within a range of a pre-determined ratio), and inform and/or cause the second counter electrode to provide the second working electrode with the current needed to adjust the ratio into the desired range. In one embodiment, the third electrode set is configured to assess whether the electric potential is within a predetermined range and inform the potentiostat when the electric potential of the fueled molten salt is outside of the predetermined range. The interaction and operations of the second and third electrode sets is referred to as the feedback system or feedback loop.

The extraction system may be positioned in close proximity to an outlet of the core of the MSR system to increase its yield. Some of the molybdenum in the molten salt reactor is likely to exist in the form of Mo⁶⁺. The highest concentration of Mo⁶⁺ may be in the fueled molten salt that is in close proximity to the reactor core. The high concentration of fission products nearest to the reactor core may be due to molybdenum's tendency to react with other ions (e.g., uranium(III)) as it travels throughout the molten salt reactor. Therefore, it is advantageous to position the first working electrode or the entirety of the extraction system as close to the reactor core as practically possible. Embodiments of the present invention contemplate a variety of placements of the first working electrode and overall extraction system throughout the molten salt reactor system in order to balance the need for fission product capture and practicality of electrode circuit placement. In one embodiment, the extraction system is positioned at the outlet of the reactor vessel. One of ordinary skill in the art will appreciate the need to balance these two factors and understand that while the present disclosure describes the extraction system (i.e., electrode sets) as being positioned close to the reactor core, it may be placed practically anywhere within the molten salt reactor system depending on the need.

Deposited material of reduced fission products, such as ⁹⁹Moⁿ⁺ accrue on the surface of the first working electrode and buildup over time. The first working electrode can be removed from the system periodically to collect the deposited material, and then returned to the system. The first working electrode may be removed after a specified amount of time, when other parameters are met, or simply whenever it is desirable to do so. In certain embodiments, the first working electrode is a single-use electrode, which can be removed from the system to collect the deposited material and then replaced with a new electrode. Certain fission products that have adhered to the first working electrode, such as Mo-99, can be dissolved with a solvent and subsequently isolated and/or purified through known methods following removal of the first working electrode. Any suitable protocol for the dissolution and purification of the fission products (e.g., ⁹⁹Mo⁰) known in the art can be used with the present extraction system to collect the deposited. Furthermore, any suitable protocol for the removal of the first working electrode known in the art can be used to safely remove the first working electrode.

The extraction system may be placed on a bypass to facilitate flow of the molten salt to the extraction system without disturbing the remaining MSR system. The extraction system may be placed adjacent to a main piping of an MSR system by the bypass piping system. Inclusion of a bypass piping system in this positioning allows for two paths for the molten salt to flow, one path directs the molten salt through the extraction system, while the other path bypasses the extraction system. This may be accomplished through a plurality of bypass valves and pipes. This positioning is advantageous for removal of the first working electrode. By redirecting the flow of molten salt away from the extraction system, the extraction system can be drained of molten salt, by a drainage valve and pipe, isolating the electrodes from molten salt facilitating safe extraction. Furthermore, this positioning is advantageous for removal of other electrodes or maintenance of the extraction system without requiring a full shut down of the MSR system.

The first working electrode of the extraction system may be a number of different geometric configurations based on the need. Deposition of fission products onto the first working electrode may require physical contact with the first working electrode. While it may be desirable to maximize contact with the first working electrode the flow of the molten salt must not be too disturbed as to cause damage to the MSR system (i.e., by increasing pressure within the system). Therefore, the present invention contemplates a plurality of electrode configurations, positions, and shapes to balance these needs.

The first working electrode may comprise a plurality of electrodes, rather than just a single electrode. The first working electrode may be cylindrical, rectangular, circular, cone shaped, and/or any combination thereof. The working electrode may be configured as a mesh screen or checkerboard spanning the entire cross-section of a pipe of the extraction system. The mesh screen working electrode may comprise a plurality of holes to enable the molten salt to flow through the plurality of holes while still contacting fission products. While specific examples of working electrode configurations are disclosed here, one of ordinary skill in the art will appreciate that the present invention is adaptable to include at least one working electrode with any conceivable geometry and that the specific examples described herein should not be construed as limiting. Rather, the illustrated examples serve to represent that the present invention includes at least one first working electrode configured to strike a balance between fission product capture, and uninterrupted molten salt flow. This balance may be altered depending on the parameters of the MSR system, the need for fission product collection efficiency, and/or the system's sensitivity to disruption in molten salt flow.

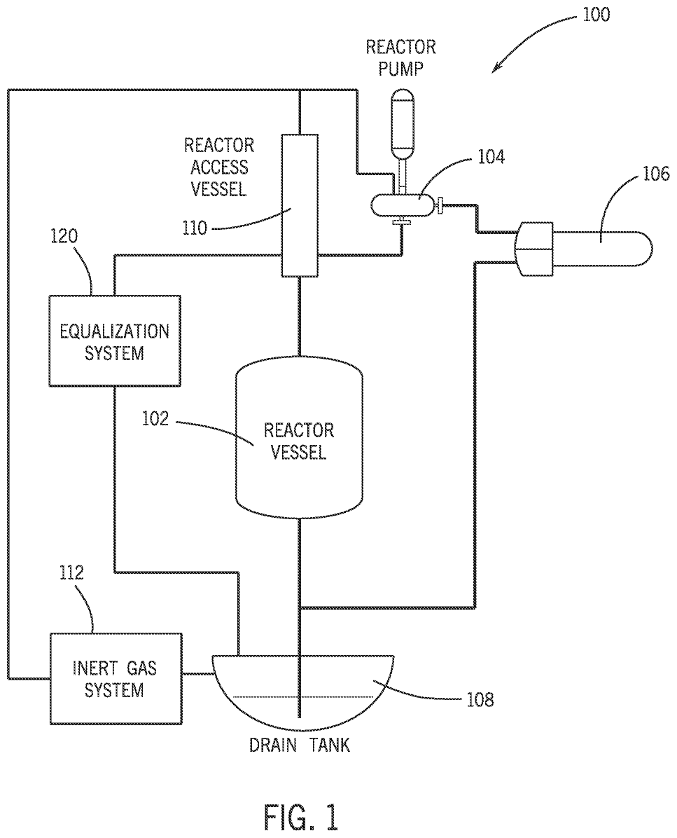

Turning to the Drawings, FIG. 1. Illustrates a schematic representation of an example molten salt reactor (MSR) system 100. The molten salt reactor system 100 is depicted and described herein to illustrate example process equipment with which the various extraction systems and associated apparatuses of the present disclosure may be used. Accordingly, while the molten salt reactor system 100 is described herein, it will be appreciated that extraction systems and associated apparatuses may be used with a variety of process equipment to extract fission products from fueled molten salt of an MSR system. As will be understood by one of ordinary skill in the art, the example shown in FIG. 1 represents merely one example configuration of a molten salt reactor system 100 in which an extraction system and associated components may be implemented; in other examples, the extraction system may be implemented with substantially any other nuclear reactor system. Furthermore, while the extraction system of the present disclosure is not included in FIG. 1, one of ordinary skill in the art will appreciate that inclusion of the extraction system illustrates the modularity of the MSR system 100.

The example molten salt reactor system 100 of FIG. 1 may be operable to utilize fuel salt enriched with uranium (e.g., high-assay low-enriched uranium) to create thermal power via nuclear fission reactions and produced irradiated fueled molten salt. The composition of the fuel salt may be LiF—BeF₂—UF₄, though other compositions of fuel salts may be utilized as fuel salts within the reactor system 100. The fuel salt within the system 100 is heated to high temperatures (such as 600° C. or greater) and melts as the system 100 is heated.

As shown in FIG. 1, the molten salt reactor system 100 includes a reactor vessel 102 where the nuclear reactions occur within the molten fuel salt, a fuel salt pump 104 that pumps the molten fuel salt to the components of the MSR system 100 (e.g., reactor access vessel 110, reactor pump 104, heat exchanger 106, etc.), such that the molten fuel salt re-enters the reactor vessel after flowing through the components of the MSR system 100, and piping in between each component. The molten salt reactor system 100 may also include additional components, such as, but not limited to, drain tank 108, inert gas system 112, and equalization system 120.

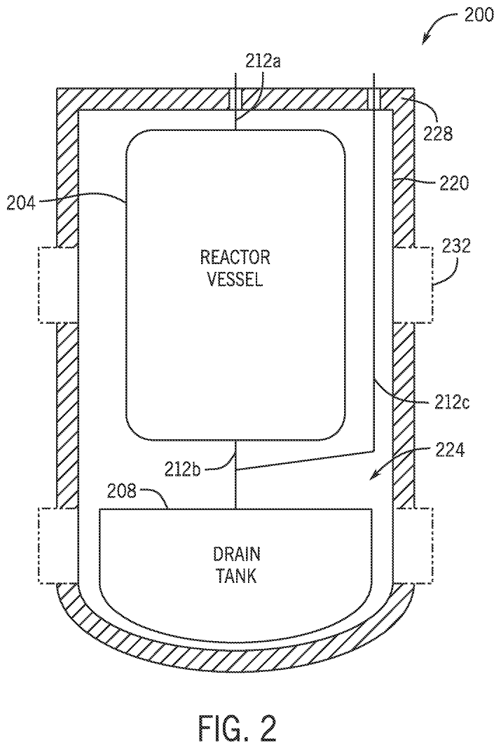

For example, MSR systems may also be configured to include additional components and systems or exclude certain components or systems. Turning to FIG. 2, as an example, the MSR system may include a Reactor Thermal Management System (RTMS) 200 configured to maintain and/or control a temperature of a reactor vessel 204 and a drain tank 208. Additionally, the MSR system including an RTMS 200 may encompass the reactor vessel 204, the drain tank 208 and include various piping (e.g., 212b, 212a, and 212c) forming a molten salt loop. The RTMS shown in FIG. 2 may include an internal shield or vessel 220 that defines a thermally insulative region 224 thereabout, an insulative layer 228, and optional heaters 232. The various extraction systems and associated apparatuses of the present disclosure may be used with a MSR having such RTMS. In this regard, the various extraction systems may be configured to extract fission products at the substantially high temperature maintained within such RTMS. It will be appreciated that in other examples, other components and arrangements of MSR are possible and contemplated herein for use with the extraction systems of the present disclosure.

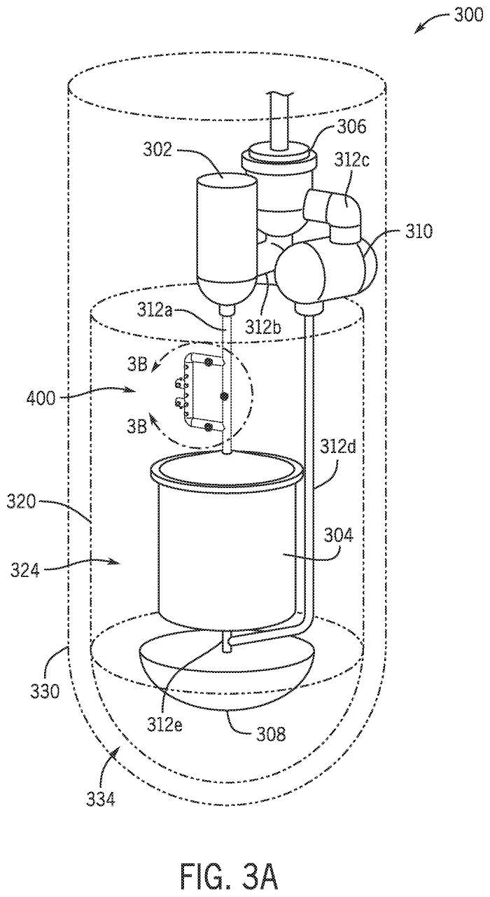

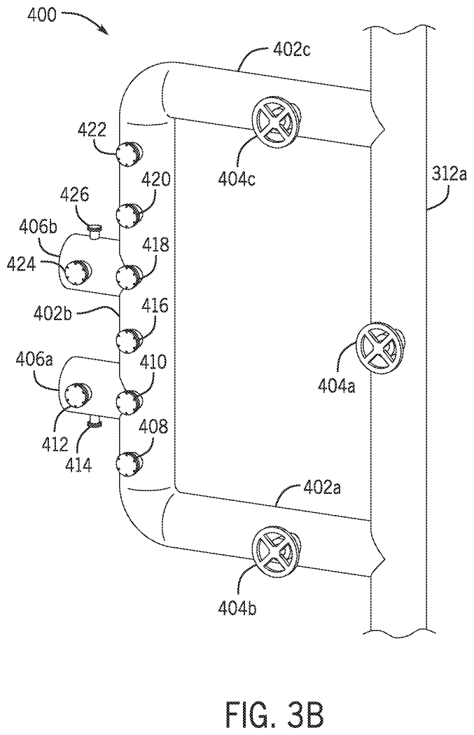

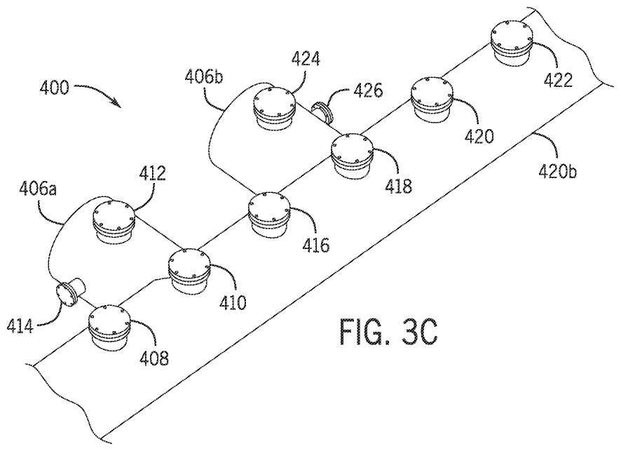

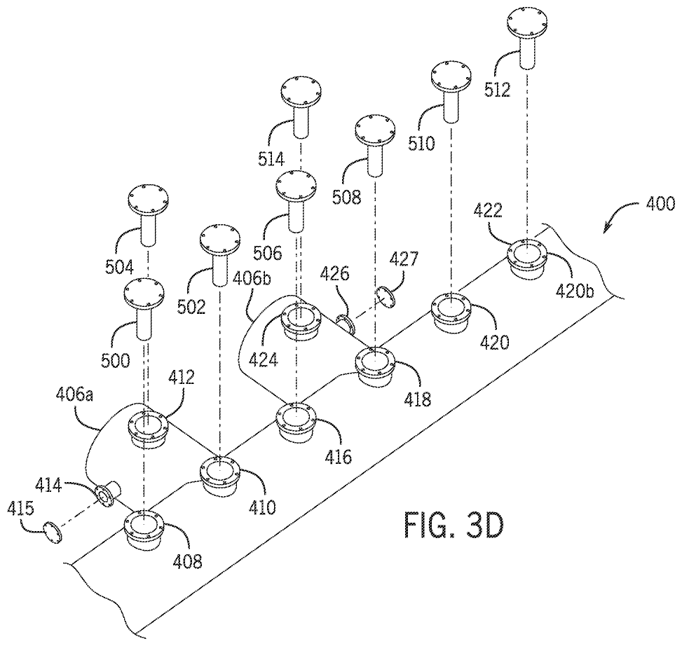

Turning now to FIG. 3A, the system 300 is shown including a molten salt loop having a reactor vessel 304, a drain tank 308, a reactor access vessel 302, a reactor pump 306, a heat exchanger 310, a reactor enclosure 330, an internal shield 320, a first thermally insulative region 324, a second thermally insulating region 334, and piping 312a, 312b, 312c, 312c, 312d, 312e, which may be substantially analogous to like components described above in relation to FIG. 1. These components may be utilized by the MSR in order to control the temperature of different regions of the MSR (i.e., having one salt bearing region be a different temperature than another salt bearing region). The reactor enclosure 330 may be constructed from a thermally insulative metal (including certain stainless steels) that is capable of withstanding substantially high temperatures, such as temperatures in excess of 600° C. The reactor enclosure 330 is shown, schematically, as encompassing the entirety of the internal shield 320 and any other salt-bearing components that are not otherwise included with the internal shield 320. For example, the reactor enclosure 330 may define a second thermally insulative region 334 that receives the internal shield 320 and all the salt-bearing components that are not held within the first thermally insulative region 324. The internal shield 320 and the reactor enclosure 330 may therefore each define a containment barrier about the salt-bearing components of the system 300. Further, the internal shield 320 and the reactor enclosure 330 may define a substantially high-radiation and high-temperature zone of the system 300.

The system 300, as described herein, may be configured to generate heat energy via nuclear fission reactions with the molten fuel salt that is circulated through, among other components, the reactor vessel 304. As previously discussed, heat generation via nuclear fission generates a plurality of fission products (including Mo-99) as a byproduct of nuclear decay. Following fission, the salt is processed, thus carrying the desirable fission products through the system 300. The fueled molten salt may be carried, by the pump 106, throughout the components of the system 300 through a molten salt “loop” comprising piping 312a, 312b, 312c, 312d, and 312e. For example, the molten fuel salt may circulate through a fuel salt system “loop” including the reactor vessel 304, the primary access vessel 302, the pump 306, and the heat exchanger 110. Broadly, the fueled molten salt may exhibit an elevated temperature at an exit of the reactor vessel 304 as a result of fission reactions occurring therein. Such elevated temperature fueled molten salt may circulate through the fuel salt loop until the salt reaches the heat exchanger 310. At the heat exchanger 310, said heat may be extracted from the fuel salt. In turn, the lower temperature molten fuel salt may continue to circulate through the fuel salt loop until it reaches the entrance to the reactor vessel 304, within which the salt may again increase in temperature via nuclear fission reactions. The process may repeat.

FIG. 3A further illustrates an extraction system 400 positioned within the molten salt reactor system 300. The extraction system 400 may be arranged along and fluidically coupled with an outlet of the reactor vessel 304. In this regard, the extraction system 400 may receive a flow of molten salt from the reactor core upon exit therefrom, such that the molten salt includes fission products due to the induced fission occurring with the reactor vessel 304. The extraction system 400 may be implemented in an MSR system 300 with or without additional components, such as a RTMS 200 of FIG. 2.

FIG. 3A illustrates the extraction system 400 as being positioned in close proximity to an outlet of the reactor vessel. The extraction system 400 may therefore be positioned along the molten salt loop to receive a flow of molten salt having the highest concentration of desirable fission products to facilitate efficient capture of said products from the fluid. Furthermore, the extraction system 400 may be positioned on piping 312a and provide an alternate flow path of fueled molten salt from the reactor vessel 304 to the reactor access vessel 302. The extraction system 400 may include at least one bypass valve and at least one bypass pipe in order to alter the flow of fueled molten salt from the reactor vessel 304 through the extraction system 400 and to the reactor access vessel 302 or from the reactor vessel 304 directly to the reactor access vessel. The bypass valve and at least one bypass pipe may be configured to facilitate flow simultaneously through the extraction system and directly from the reactor vessel 304 to the access vessel 302.

However, while the extraction system 400 is illustrated as being positioned on piping 312a between the reactor vessel 304 and the access vessel 302, the extraction system may be positioned at any suitable location within the system 300. For example, the extraction system may be positioned on piping 312b, on piping 312c, on piping 312d, or even on piping 312e. Additionally, the extraction system 400 may be configured such that each individual electrode set positioned at different locations within the system 300. For example, the first electrode set may be positioned on piping 312a, while the second electrode set is position on piping 312b, and while the third electrode set is positioned on piping 312d. One of ordinary skill in the art will appreciate that the positioning of the extraction system 400, as illustrated in FIG. 3A, should not be construed as limiting, rather FIG. 3A illustrates an exemplary positioning of the extraction system 400 in the system 300. The extraction system 400 may be positioned on any piping 312a, 312b, 312c, 312d, or 312e, such that it is in fluid communication with the reactor vessel 304. Similarly, while FIG. 3A may illustrate the extraction system 400 as being oriented substantially vertically, the extraction system 400 may be oriented horizontally or in a variety of different configurations.

Advantageously, by including an extraction system 400 within a system 300 that is capable of being positioned in a variety of locations, the extraction system 400 may be installed in such a location that is more practical to maintain, repair, access, or to accommodate spatial constraints of the physical implementation of the system 300. Lastly, while FIG. 3A illustrates the extraction system 400 as being of a particular size and shape relative to the remaining components, this should not be construed as limiting, rather the extraction system 400 is illustrated for viewing ease, such that it is easily identifiable on the system 300. The extraction system 400, may be larger or small than that depicted in FIG. 3A.

FIGS. 3B and 3C illustrate an exemplary configuration of the electrochemical extraction system 400. In this exemplary configuration, the extraction system 400 is positioned adjacent to piping 312a and forms a bypass through piping 402a, 402b, and 402c. However, the extraction system 400 may be positioned adjacent to any of the piping illustrated in FIG. 3A. Piping 402a, 402b, and 402c, as used herein, may be collectively referred to as the conduit. The conduit may include a plurality of piping and bypass valves in order to permit or prevent flow of fueled molten salt to a plurality of electrode sets. Piping 312a may include a bypass valve 404a in order to permit passage of fueled molten salt or prevent passage of molten salt when open and closed respectively. Piping 402a may include bypass valve 404b and piping 402c may include bypass valve 404c in order to facilitate flow of molten salt through the extraction system 400 and back through piping 312a. The plurality of piping and bypass valves may be ordered in such a way as to facilitate flow of molten salt through extraction system 400. Additionally, while valves 404a, 404b, and 404c are illustrated with manual adjusting mechanisms, they may be implemented to be automatically or remotely adjustable to accommodate the practical implementation of the extraction system 400.

In order to facilitate flow of the fueled molten salt to the extraction system, first valve 404c may be opened, followed by valve 404b, and then valve 404a may be closed. While FIG. 3B illustrates valves 404a, 404b, and 404c as being placed substantially in the middle of their respective piping, the plurality of valves may be placed anywhere along the length of their respective piping. Following this explanation, the valves 404b and 404c may be positioned at the intersection between piping 402a and 312a and the intersection between piping 402c and 312a respectively. The extraction system 400 may be configured such that irradiated fueled molten salt flows from piping 312a, through piping 402a and bypass valve 404b, to piping 402b, to piping 402c and bypass valve 404c, and back into piping 312a, as a nonlimiting example. This configuration may be implemented where it is desirable for the fueled molten salt to initially contact the first electrode set, following by contacting with the second electrode set, and finally by contacting the third electrode set.

The extraction system 400 may further include a first counter electrode chamber 406a and/or a second counter electrode chamber 406b. The first counter electrode chamber 406a and the second counter electrode chamber 406b may be attached to piping 402b and operable to house unfueled molten salt and associated counter electrodes. The counter electrode chambers 406a and 406b may be configured to extend perpendicularly from piping 402b. Counter electrode chambers 406a and 406b may further include means to attach the counter electrodes, such as flanges 412 and 424. Furthermore, each counter electrode chamber (406a, 406b) may include means to facilitate filling or emptying of molten salt, such as port 414 and port 426.

Counter electrode chamber 406a and 406b may be separated from an interior of piping 402b by a porous membrane. The porous membrane may be included to create a semipermeable barrier to prevent and/or slow mixing of unfueled molten salt of the counter electrode chambers (406a, 406b) with the irradiated fueled molten salt flowing through piping 402b. The porous membrane further facilitates electric communication between electrodes. Advantageously, by including porous membranes to separate the interior of the counter electrode chambers (406a, 406b), the electric circuit of the electrode sets can be complete while preventing the unfueled molten salt from mixing with the fueled molten salt of the MSR system.

In order to effectuate the installment of the electrode sets, the extraction system 400 may include a plurality of flanges, such as flanges 408, 410, 416, 418, 420, and 422, to facilitate secure attachment of a plurality of electrodes (not shown). While FIGS. 3B and 3C illustrate flange 410 as being parallel to flange 412 and flange 418 as being parallel to flange 424, that plurality of flanges may be positioned in any suitable configuration to effectuate the functions of the electrode sets. Similarly, while FIGS. 3B and 3C illustrate counter electrode chamber 406a as extending perpendicular from piping 402b at or near flange 410 And counter electrode chamber 406b as extending perpendicular from piping 402b at or near flange 418, the counter electrode chambers 406a and 406b may be positioned at any angle relative to the piping suitable to effectuate the functions of the electrode sets. Lastly, while flanges 408, 410, 416, 418, 420, and 422 are illustrated as being positioned on piping 402b in substantially a straight line along a vertical axis of piping 402b, these too can be positioned on piping 402b in any suitable way to effectuate the functions of the electrode sets.

Advantageously, by allowing the components illustrated in FIGS. 3B and 3C to be configured in any suitable manner, the present invention can be more easily adapted to future or pre-existing MSR system. Due to factors such as, spatial constrains, maintenance needs, and accessibility needs, certain MSR systems may require that the components of the present invention be positioned at certain locations or angles. The present invention accommodates these requirements by not needing specific orientation to function, rather merely requiring that the components be placed in such a way as to enable the electrode sets to function normally, that is, for the working electrodes (or their respective flanges) to be proximal to their respective counter electrodes, in order to facilitate and electrical connection, and for the reference electrodes to be proximal to the working electrodes to act as a reference.

FIG. 3D illustrates an exploded view of an exemplary electrochemical extraction system 400 according to one embodiment of the present invention. FIG. 3D illustrates the secure attachment of the plurality of electrodes by their respective flanges. The plurality of electrodes may extend from their respective flange down into an interior volume of piping 402b, such that the plurality of electrodes are submerged in and make contact with the flow of irradiated fueled molten salt without exposing the molten salt to the exterior of the conduit. The plurality of flanges may be attached to the piping of the extraction system through bolt, screw, adhesive, and/or other suitable means.

As illustrated in FIG. 3D, the extraction system 400 may include a first reference electrode 500, a first working electrode 502, a first counter electrode 504, a second reference electrode 506, a second working electrode 508, a second counter electrode 514, a third reference electrode 510, and a third working electrode 512. The counter electrode chambers (406a, 406b) may include a port (414, 426) with an associated flange (415, 427). The plurality of electrodes may be positioned such that the flow of irradiated fueled molten salt initially contacts the first reference electrode 500 and first working electrode 502, then contacts the second reference electrode 506 and second working electrode 508, and lastly contacts the third reference electrode 510 and third working electrode 512. Stated otherwise, the third set of electrodes may be positioned downstream from the second set of electrodes, which may be positioned downstream of the first set of electrodes. The counter electrodes (504, 514) by their containment within their respective counter electrode chambers (406a, 406b), do not come in contact with the irradiated fueled molten salt. While the reference electrodes (500, 506, 510) are illustrated as being upstream of adjacent working electrodes (502, 508, and 512 respectively) they may be configured downstream of the working electrodes, where the reference electrodes are positioned parallel to the working electrodes, or any suitable electrode positioning known in the art, or any combination thereof. For example, the third electrode set may be positioned such that it initially contacts the flow of molten salt, followed by the second electrode set, which is followed by the first electrode set.

In some embodiment, counter electrode chambers 406a and 406b are not two distinct chambers, rather comprise a single or connected chamber. For example, the extraction system 400 may include only a single counter electrode chamber configured to house counter electrode 504 and counter electrode 514. In this example, the single counter electrode chamber may be configured to be a larger size, thus accommodating more unfueled molten salt to enable reaction at both counter electrodes contained therein. As another example, the extraction system 400 may include an additional piping fluidly connecting the contents of counter electrode chamber 406a with that of counter electrode chamber 406b. In this example, the additional piping is of a size to allow unfueled molten salt to flow between the counter electrode chambers 406a, 406b.

Advantageously, by including either of these configurations the extraction system 400 may not require the addition of unfueled molten salt to each counter electrode chamber. In this embodiment, the oxidized species produced at the first counter electrode 504 may react with the reduced species produced at the second counter electrode 514 This essentially causes the reduced species to be recycled and avoids buildup of excess concentrations of reacted species in the counter electrode chambers 406a, 406b. This further eliminates the need to add additional unfueled molten salt to the counter electrode chambers 406a, 406b.

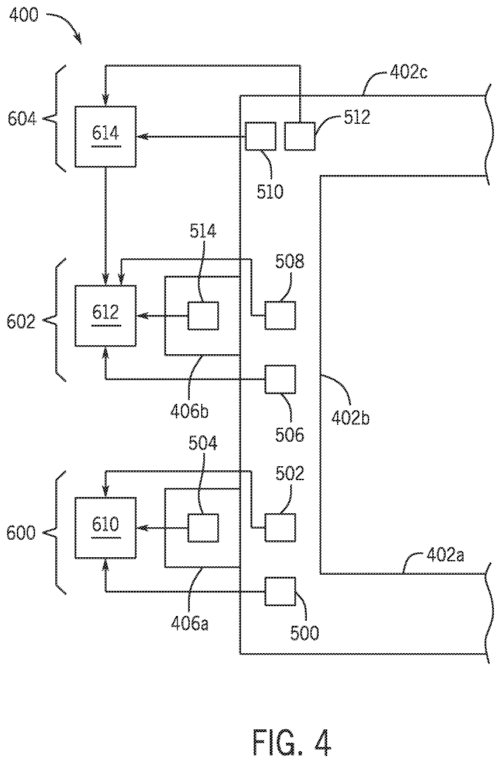

FIG. 4 illustrates an exemplary electrochemical extraction system 400 according to one embodiment of the present invention. The purpose of FIG. 4 is to illustrate three electrode sets and the electrical communication passages thereof, not for purposes of limiting the physical configurations of the components of the three electrode sets. The extraction system 400 is in fluid communication with the reactor core of a molten salt reactor system, such that the extraction system 400 may receive a flow of molten salt following induced fission in the reactor vessel. The extraction system 400 generally includes a first electrode set 600, a second electrode set 602, and/or a third electrode set 604.

The first electrode set 600 generally includes a first reference electrode (RE1) 500, a first working electrode (WE1) 502, and a first counter electrode (CE1) 504 contained in the first counter electrode chamber 406a. RE1 500, WE1 502, and CE1 504 are in communication with a first control system (Potentiostat 1) 610, which may be external to the conduit. In one embodiment, the first control system 610 is or includes the same or similar functions as the potentiostat 1800 discussed with reference to FIG. 11. RE1 500 and WE1 502 are in contact with the irradiated fueled molten salt and CE1 504 is in contact with the unfueled molten salt of counter electrode chamber 406a.

The first electrode set 600 may be operable to collected fission products from the irradiated fueled molten salt by electrochemical deposition of cations (e.g., Moⁿ⁺) of the fission products onto WE1 502. The fission products may deposit onto WE1 502 as a metal onto the solid surface of WE1 502 through reduction by means of the direct electric current provided by CE1 504 to WE1 502. The fission products may be deposited onto WE1 502 in small or large quantities, such that the electrode is completely or partially coated with metallic fission products. In one embodiment, the fission products are molybdenum ions, for example Mo⁶⁺, which is reduce to Mo⁰ upon deposition onto WE1 502. However, the present invention contemplates capture of all fission products by reduction and subsequent deposition onto WE1 502. RE1 500 provides a reference for measuring and controlling the potential of WE1 502. CE1 504 provides current to WE1 502. The first control system 610 directs and controls the functions of WE1 502, CE1 504, and RE1 500. The first electrode set 600 is included in the extraction system 400 to facilitate the capture of desirable fission products from the fueled molten salt.

CE1 504 may be positioned in a first counter electrode chamber 406a, which may be attached to the conduit. A first porous membrane may be included to separate the interior of the conduit from the interior of the first counter electrode chamber 406a. The first counter electrode chamber 406a may be filled with an unfueled molten salt composition. The unfueled molten salt composition in the first counter electrode chamber 406a comprises one or more molten salts as described herein, which may be the same or a different type of molten salt than that contained in the conduit. The first counter electrode chamber 406a may further comprise a port (comprising port 414 and flange 415 of FIG. 3D) to facilitate the addition of unfueled molten salt. The unfueled salt initially added to the first counter electrode chamber may be substantially free of one or more types of uranium fluoride compounds or include one or more types of uranium fluoride compounds. The first porous membrane may be included to facilitate electric communication between CE1 504 and WE1 502 while minimizing or eliminating mixing of the fueled and unfueled molten salt compositions. The first counter electrode chamber 406a may be positioned on the conduit near WE1 502.

The second electrode set 602 generally includes a second reference electrode (RE2) 506, a second working electrode (WE2) 508, and a second counter electrode (CE2) 514 positioned within the second counter electrode chamber 406b. RE2 506, WE2 508, and CE2 514 may be in communication with a second control system (Potentiostat 2) 612, which may be external to the conduit. In one embodiment, the first control system 610 is or includes the same or similar functions as the potentiostat 1800 discussed with reference to FIG. 11. Similar to the first electrode circuit, RE2 506 and WE2 508 may be submerged in the fueled molten salt such that they are in contact with the fueled molten salt and CE2 514 may be submerged in the unfueled molten salt such that it is in contact with the unfueled molten salt of counter electrode chamber 406b.

The second electrode set 602 is operable to adjust the balance of uranium(IV) to uranium(III) ions by oxidation of uranium(III) ions by WE2 508. RE2 506 may provide a reference for measuring and controlling the potential of WE2 508 and CE2 514 may provide current to WE2 508. The second control system 610 may direct and control the functions of WE2 508, CE2 514, and RE2 506.

CE2 514 may be positioned in a second counter electrode chamber 406b, which may further be attached to the conduit. Counter electrode chamber 406b may be positioned downstream of the first counter electrode chamber 406a. A second porous membrane may be included to separate the interior of the conduit from the interior of the second counter electrode chamber 406b. The second counter electrode chamber 406b may be filled with an unfueled molten salt composition. The unfueled molten salt composition in the second electrode chamber 406b may comprise one or more molten salts as described herein, which may be the same or different than the type of molten salt contained in the conduit or in the first counter electrode chamber 406a. The second counter electrode chamber may further include a port (comprising port 426 and flange 427 of FIG. 3D) for addition of unfueled molten salt. The unfueled salt initially added to the second counter electrode chamber 406b may be substantially free of one or more types of uranium fluoride compounds or include one or more types of uranium fluoride compounds. The second porous membrane may be included to facilitate electric communication between CE2 514 and WE2 508 while minimizing or eliminating mixing of the fueled and unfueled molten salt compositions. The second counter electrode chamber 406b may be positioned on the conduit near WE2.

The third electrode set 604 generally includes a third reference electrode (RE3) 510 and a third working electrode (WE3) 512. RE3 510 and WE3 512 are each in communication with a meter 614, which may be external to the conduit. In one embodiment, the meter 614 is or includes the same or similar functions as the potentiostat 1800 discussed with reference to FIG. 11. The meter 614 detects changes in the uranium(IV)/(III) ion balance of the molten salt by measuring the electric potential of the fueled molten salt. The meter 614 may be in communication with the second control system 612 in order to provide measurements of the fueled molten salt's electric potential. RE3 510 and WE3 512 may be submerged in the fueled molten salt such that they make contact with the fueled molten salt. By inclusion of the third electrode set 604, the second electrode set 602 can more efficiently balance the uranium(IV) to uranium(III) ratio due to being provided measurements from the third electrode set 604. In one embodiment, the third electrode set 604 does not include a corresponding counter electrode or counter electrode chamber. Downstream of RE3 510 and WE3 512, the molten salt may return to the MSR system.

The third electrode set 604 measure the electric potential of the fueled molten salt, which provides an indirect determination of the uranium(IV) to uranium(III) ratio of the fueled molten salt. This information may be provided to the second control system 612, where a determination is made on whether the electric potential of the fueled molten salt is outside of a predetermined range. When the electric potential is outside of the predetermined range (as indicated by meter 614), the second control system 612 may activate WE2 508 (causing oxidation of uranium(III) ions). When the electric potential is within the predetermined range, the second control system 612 may deactivate or not activate WE2 508 (halting oxidation of uranium(III) ions). As discussed in more detail later, the second electrode set 602 and third electrode set 604 effectuate the automatic feedback mechanism to counteract the negative effects of the first electrode set 600. The second electrode set 602 and third electrode set 604 functions together to measure the electric potential of the fueled molten salt and correct said electric potential, such that damage to the MSR system is avoided.

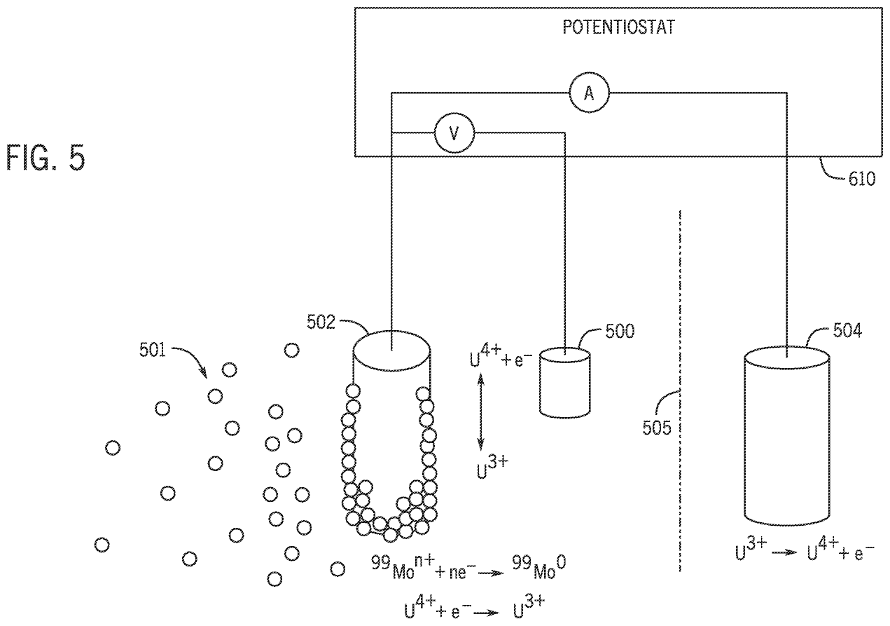

FIG. 5 illustrates an exemplary three-electrode circuit according to one embodiment of the present invention and illustrates the electrochemical deposition of fission products occurring at the first electrode set. The fueled molten salt may contain fission products which may be in an oxidized stated. For example, molybdenum-99 in various oxidation states (represented by ⁹⁹Moⁿ⁺) may be found in the fueled molten salt. These oxidized fission products may be captured through electrochemical deposition by inclusion of a working electrode provided with charge by a counter electrode. Electrochemical deposition occurs where there is an exchange of electrons or charge at the surface of the working electrode. Upon contact with the working electrodes, oxidized fission products may be discharged and adhere to the working electrode, effectuating fission product capture. The counter electrode is included to provide current and complete the circuit, such that the working electrode is provided with a charged surface. The reference electrode is included to act as a reference for measuring and controlling the working electrode potential. FIG. 5 further illustrates example chemical reactions occurring at each electrode or electrode set. For example, uranium(IV) is reduced to uranium(III) and discharges an electron at WE1 502. As another example, molybdenum-99 cations are reduced to metallic molybdenum-99 (i.e., ⁹⁹Mo⁰) at WE1 502. As another example, uranium ions may interact with other components of the molten salt and may consequently oxidize and reduce. As another example, uranium(III) ions may be oxidized to uranium(IV) ions at CE1 504.

The first electrode circuit may comprise WE1 502, RE1 500, CE1 504, the first control system 610, and the first porous membrane 505. FIG. 5 illustrates the chemical interaction occurring between the electrode sets of FIG. 4 and the fueled molten salt. For ease of illustration, fission products 501 (e.g., molybdenum ions) are represented by the plurality of circles, however they are not drawn to size and serve to merely represent the accumulation of fission products 501 onto WE1 502. WE1 502 can provide a negatively charged surface upon which positively charged fission products can deposit. The first electrode set is operable to facilitate electrochemical deposition of fission products onto WE1 502 by the application of current to WE1 502 by CE1 504. Upon deposition, the fission products (metallic ions prior to deposition) become solid metal particles and deposit onto the surface of WE1 502. Stated otherwise, the positively charged ions of the fission products migrate to WE1 502 where they are discharged and deposited as a metal upon contact. CE1 504 provides a sufficient amount of electric current through the unfueled molten salt (i.e., electrolyte solution) to WE1 502 in order to reduce fission products and complete the circuit. RE1 500 provides a reference for measuring and controlling the potential of WE1 502. The first porous membrane 505 provides for electric communication between WE1 502 and CE1 504, while slowing or preventing mixing of the fueled molten salt with the unfueled molten salt. As illustrated by FIG. 5, WE1 502 may also cause uranium(IV) ions to reduce to uranium(III) ions. While FIG. 5 illustrates a simplified exemplary configuration of a three-electrode setup, one of ordinary skill in the art will appreciate that other setups known in the art may be utilized to effectuate the same mechanism (i.e., a two-electrode setup).

However, one of ordinary skill in the art will also appreciate the exemplary purpose of FIG. 5 and understand that the principles, components, and mechanism described in reference to FIG. 5 and the first electrode set, in combination with the present disclosure, is applicable to the second and third electrode set.

The second electrode set works under the same principles as illustrated in FIG. 5 but may be configured in the reverse in order to reestablish the redox of the fueled molten salt of the conduit. To this end, WE2 may provide a positive surface upon which uranium(III) ions are oxidized to form uranium(IV) ions and CE2 may provide a sufficient amount of electric current through the unfueled molten salt to WE2 in order to oxidize uranium(III) ions and complete the circuit. Meanwhile, RE2 may provide a reference for measuring and controlling the potential of WE2. The second porous membrane may provide for electric communication between WE2 and CE2, while slowing or preventing mixing of the fueled molten salt with the unfueled molten salt. The third electrode circuit may function under the same principles as illustrated in FIG. 5 with the exclusion of a corresponding counter electrode. The third electrode circuit may include WE3 and RE3 in functional communication with a meter. The third electrode circuit is operable to measure the electric potential of the fueled molten salt. The meter may be in functional communication with the second control system.

In some embodiments, the porous membrane 505 includes embedded cations to discourage or eliminate passage of cations contained in the molten salt from passing through the porous membrane 505. The porous membrane 505 may be lined with cations prior to installation into the extraction system. The embedded cations may be of a specific concentration as to prevent or greatly reduce the amount of uranium(III) and uranium(IV) ions from passing through the porous membrane 505 while allowing fluoride anions to pass through the porous membrane 505. Advantageously, by providing a porous membrane 505 with embedded cations, electrical contact between the counter electrodes and workings electrodes are maintained and mixing of components of the molten salt is controlled, reduced, and/or eliminated. In some embodiments, the porous membrane 505 may be configured to be highly conductive of cations, resistant to chemical attack or deterioration, and/or highly stable at high temperatures.

In some embodiments, the counter electrode chambers are separated from the molten salt of the conduit by a single pore or pinhole. In these embodiments, the counter electrode chambers include an impermeable panel or plate that includes the single pore or pinhole. The single pore may be configured to be of a relatively small size in relation to the impermeable panel. The single pore may further be configured to allow electrochemical contact with the fueled molten salt of the conduit (e.g., piping 402b) while minimizing the mixing of unfueled molten salt with the fueled molten salt. In this embodiment, the counter electrode chamber may be configured to have a positive pressure, relative to that of the conduit. Advantageously, this configuration provides that where there is a leak or mixing of unfueled molten salt with fueled molten salt through the single pore it is in the direction of the counter electrode chamber towards the working electrode. By providing positive pressure in the counter electrode chamber, leakage of fueled molten salt into the counter electrode chamber is discourage or eliminated.

In order for fission products to be deposited onto WE1, fission product cations may be required to make contact with WE1. While the conduit may be configured to facilitate flow of fueled molten salt (from the core of the molten salt reactor system) to WE1, the geometric configuration of WE1 must be such that it makes physical contact with the fueled molten salt. In order to maximize the yield of the extraction system, WE1 is configured to maximize contact with the fueled molten salt. However, not so much so that the fueled molten salt is disrupted to a dangerous level.

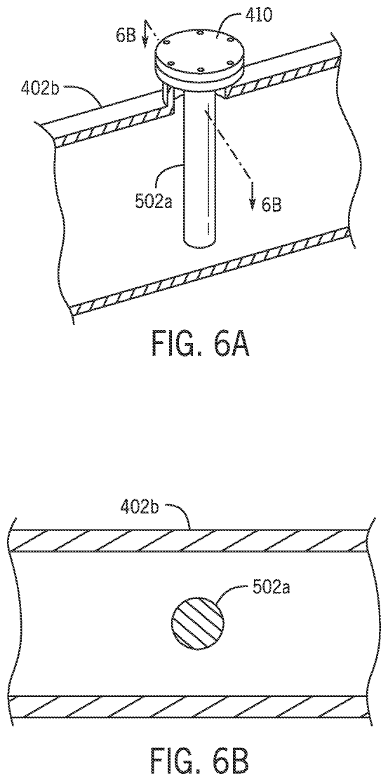

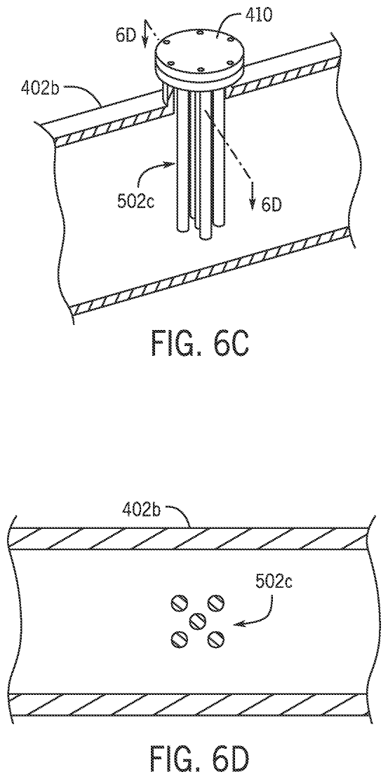

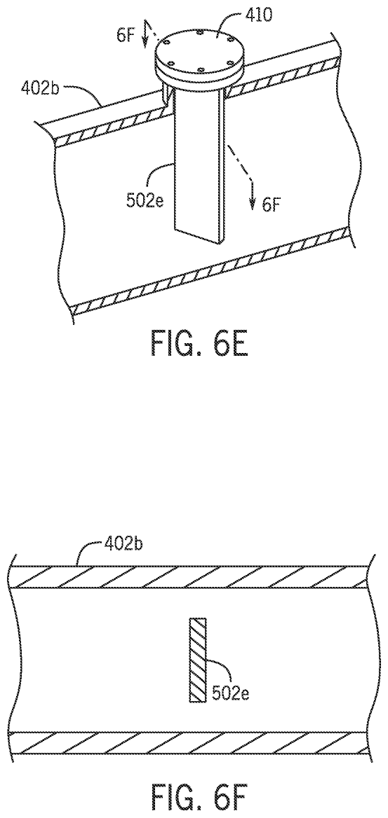

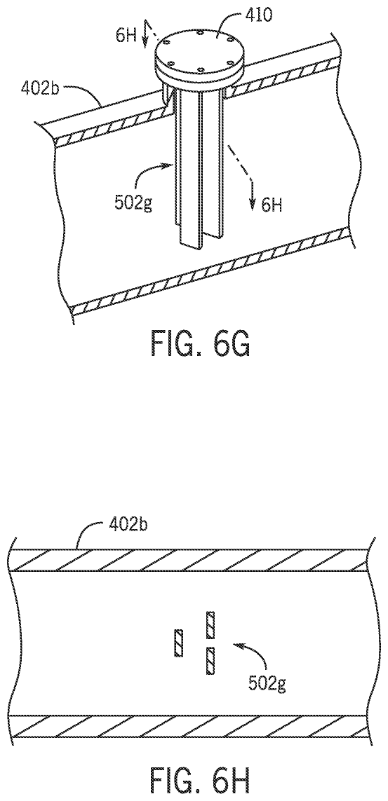

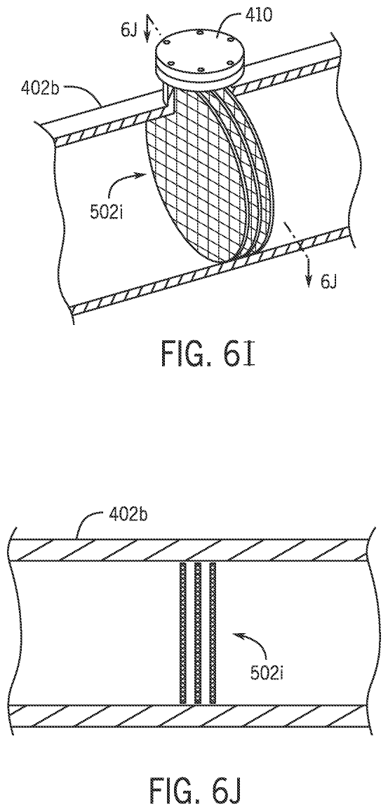

Two primary factors contribute to the efficiency of the extraction system to collect fission products (i.e., the ratio of desired fission products deposited vs. total desired fission products produced by the molten salt reactor system). First, the proximity of WE1 to the core of the reactor and second the geometry of WE1. The proximity of WE1 to the core of the reactor contributes to the efficiency of the extraction system by being in a position where the highest concentration of fission products (e.g., molybdenum cations) is present. The geometry of WE1 contributes to the efficiency of the extraction system by maximizing contact with the fueled molten salt while not disrupting the flow of fueled molten salt (resulting in increase of pressure). Disruption of fueled molten salt flow and resulting increased pressure can cause harm to the molten salt reactor system. Therefore, in order to maximize contact with WE1, while not damaging the system, a variety of geometric configurations are contemplated. These various configurations are illustrated in FIGS. 6A-6J.

FIGS. 6A-6J illustrate exemplary embodiments of geometric configuration of the WE1 502 within piping 402b. While FIGS. 6A-6J illustrate a variety of geometric configurations, one of ordinary skill in the art will appreciate that these illustrations should not be construed as limiting, rather they will be construed as exemplary towards the purposes of balancing the ability for WE1 to contact fission products without detrimentally hindering fueled molten salt flow. Furthermore, different geometric configurations may be more suitable for certain molten salt reactor systems than others. This is because molten salt reactor systems may include molten salt at varying temperatures, pressures, and compositions, which may allow more or less leniency in the increase of pressure WE1 can cause without harming the system.

FIG. 6A illustrates an isometric view of WE1 502a within piping 402b, secured by flange 410 and FIG. 6B illustrates a cross-sectional view of the WE1 502a of FIG. 6A taken along line 6B-6B of FIG. 6A. FIGS. 6A-6B illustrate how WE1 502a may be cylindrical and extend from flange 410 into piping 402b, such that fueled molten salt contacts WE1 502a while flowing through piping 402b. The cylindrical WE1 502a extends substantially to a bottom portion of piping 402b and may have a diameter about a third of the diameter of piping 402b. The cylindrical configuration may be advantageous by occupying a substantial portion of the interior of piping 402b, thus contacting much, all, or substantially most of the fueled molten salt, while providing a curved exterior to avoid substantial disruption to the flow of fueled molten salt.

FIGS. 6C and 6D illustrates views analogous to that of FIGS. 6A and 6B and include analogous components. FIGS. 6C-6D illustrates how WE1 502c may comprise a plurality of cylindrical electrodes, rather than just a single electrode. The plurality of electrodes of WE1 502c may be spaced to allow fueled molten salt to flow between each electrode of the plurality of electrodes. The plurality of cylindrical electrodes configuration may be advantageous by allowing fueled molten salt to flow through and in between and around the electrodes, provide multiple electrodes for contact with the molten salt, and by providing electrodes with curved surfaces to avoid substantial disruption to the flow of fueled molten salt.

FIGS. 6E and 6F illustrates views analogous to that of FIGS. 6A and 6B and include analogous components. FIGS. 6E-6F illustrate how WE1 502e may be configured to prioritize fueled molten salt contact with WE1 502e over disruption to the flow of fueled molten salt. The rectangular WE1 502e configuration may be advantageous where the user wishes to maximize capture of fission products and where the MSR system is resistant to pressure change.

FIGS. 6G and 6H illustrates views analogous to that of FIGS. 6A and 6B and include analogous components. FIGS. 6G-6H illustrate how WE1 502g may comprise a plurality of rectangular electrodes. The plurality of rectangular electrodes of WE1 502g may be spaced to allow fueled molten salt to flow between each electrode of the plurality of electrodes. The plurality of rectangular electrodes of WE1 502g configuration may be advantageous where it is desirable to include rectangular electrodes but also desirable to include a plurality to enable fueled molten salt between each electrode of the plurality of electrodes of WE1 502g.

FIGS. 61 and 6J illustrates views analogous to that of FIGS. 6A and 6B and include analogous components. FIGS. 6I-6J illustrate how WE1 502i may comprise a plurality of circular electrodes that are substantial flat with a plurality of holes created by gaps left by intersecting lines in a checker-board pattern. WE1 502i may comprise a plurality of circular electrodes, each formed by a plurality of intersecting or woven wires that form holes about each intersection. The plurality of mesh electrodes of WE1 502i may have a diameter substantially the same as the diameter of piping 402b, such that each mesh electrode of WE1 502i spans the entire cross-sectional area of piping 402b. In order to install the plurality of mesh electrodes of WE1 502i may be flexible in order to be placed within piping 402b through an opening above piping 402b. Additionally, piping 402b may include a wider opening and corresponding flange to accommodate the plurality of electrodes of WE1 502i in the form of a rectangular flange or a plurality of slits positioned on piping 402b. FIGS. 6I-6J illustrate the preferred embodiment of WE1, that maximizes the contact with fission products while minimizing flow disruption. While FIGS. 6I-6J illustrate WE1 502i with three mesh electrodes, the present invention contemplates any number of mesh electrodes spanning a length of piping 402b including more than three and less than three.

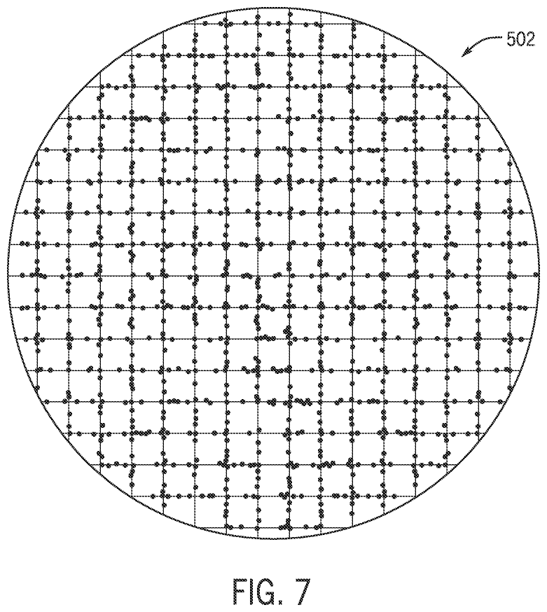

FIG. 7 illustrates an orthogonal view of WE1 comprising a mesh electrode 502 according to one embodiment of the present invention. FIG. 7 illustrates the preferred configuration of WE1, such that the contact with fission products is maximized while flow disruption is minimized. Similar to FIG. 5, deposited fission products (e.g., metallic molybdenum) is represented by a plurality of dots on the mesh frame of WE1. However, these dots are not drawn to scale and are illustrated for ease of understanding how the fission products are collected. The fission products may be attracted to WE1 502 following application of current and accumulate on the surface of WE1 502 through electrochemical deposition. The fission products may be reduced upon contact with WE1 502 and adhere to its surface. The deposition of metallic fission products may create a thin layer on the surface of WE1 502. The mesh WE1 502 of FIG. 7 comprises a plurality of intersecting points and a plurality of square or rectangular gaps creating a checker-board pattern. This configuration enables fueled molten salt to flow through the WE1 while contacting WE1 in order to encourage deposition.

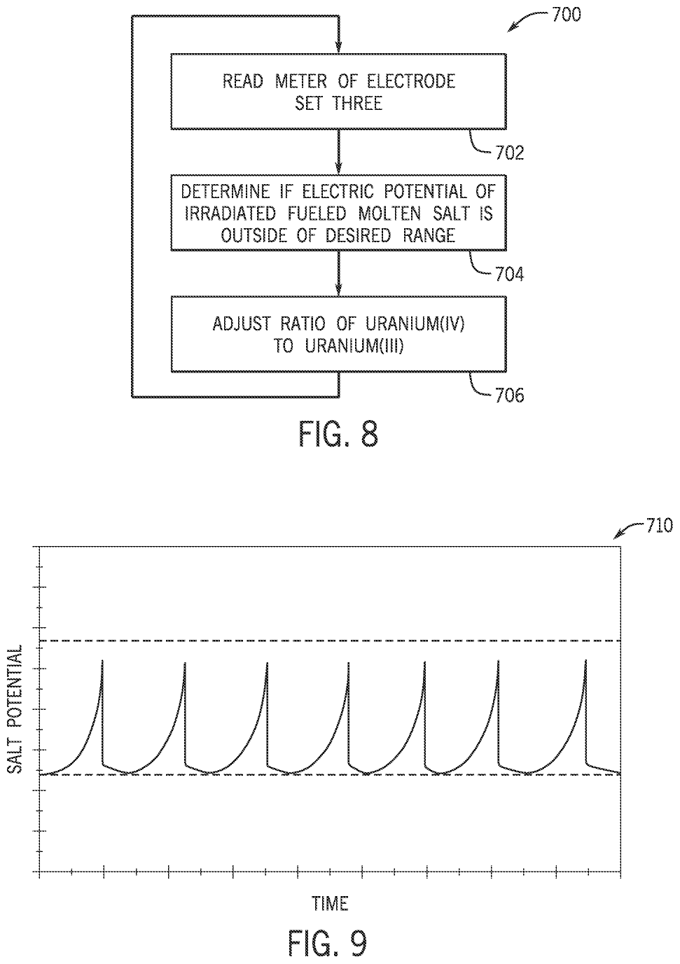

FIG. 8 illustrates a flow diagram for a feedback loop 700 according to one embodiment of the present invention. FIG. 8 illustrates an automatic feedback loop 700 facilitated by the second electrode set and third electrode set of the extraction system of the present invention. The feedback loop 700 may comprise a plurality of steps, facilitated by the components and systems of the extraction system. FIG. 8 illustrates a self-correcting mechanism to counteract the undesired effects of including WE1 into the extraction system. Stated otherwise, FIG. 8 illustrates the feedback loop to balance the redox of the irradiated molten salt. The feedback loop 700 may be facilitated by the second electrode set 602 of FIG. 4 and the third electrode set 604 of FIG. 4. At step 702, the meter of the third electrode set may be read by the potentiostat of the second electrode set and then proceeds to step 704. Step 702 may be performed by the meter 614 of FIG. 4 providing the potentiostat 612 of FIG. 4 with a measurement of the electric potential of the fueled molten salt. At step 704, the potentiostat of the second electrode set may determine that the electric potential of the irradiated fueled molten salt is outside of a predetermined range and then proceeds to step 706. Step 702 may be performed by the potentiostat 612 of FIG. 4 determining that the reading of meter 614 is outside of a predetermined electric potential range. At step 706, the ratio of uranium(IV) to uranium(III) may be adjusted by supplying current to WE2 (i.e., turning on WE2) and then proceeds back to step 702. Step 706 may be performed by the potentiostat 612 of FIG. 4 providing WE2 508 of FIG. 4 with current and WE2 of FIG. 4 facilitating said ratio adjustment. The feedback loop 700 may continually monitor the electric potential of the fueled molten salt through the meter, or the meter of the third electrode set may be configured to send measurements to the potentiostat of the second electrode set automatically at predetermined times or manually.

The present invention contemplates a variety of implementations of the feedback system. As a nonlimiting example, the potentiostat of the second electrode set may completely shut off the second working electrode (i.e., provide no current to the electrode) in response to the meter of the third electrode set reading a uranium(IV) to uranium(III) ratio within a desired range and turn on the second working electrode in response to the meter reading a ratio outside the desired range. As another nonlimiting example, the potentiostat of the second electrode set may cause a variable amount of current to be provided to the second working electrode in response to readings of the meter of the third electrode set. This embodiment may be used where a specific or variable reaction rate is desired in order to slowly or quickly adjust the uranium ion balance of the molten salt composition. Additionally, the potentiostat of the second electrode set may be configured and reconfigured to meet the desires of the operator of the MSR system.

FIG. 9 illustrates an example electric potential range 710 for a feedback loop according to one embodiment of the present invention. Such an electric potential range 710 may be read by the meter 614 of FIG. 4. The potential range 701 may assessed by plotting a ratio of the electric potential of the fueled molten salt with that of a reference potential (e.g., Mg⁰/Mg²⁺) and plotted by time in days. The potential range 701 may be set by the potentiostat 612 of FIG. 4 As a nonlimiting example, the predetermined desired range of electric potential of the fueled molten salt may be set between 0.25 and 0.65 of that of the reference potential, as illustrated in FIG. 9. However, one of ordinary skill in the art will appreciate that FIG. 9 illustrates an exemplary range according to one embodiment of the present invention and that any predetermined range may be used in the feedback loop and by potentiostat 614 of FIG. 4. Additionally, the predetermined range may be implemented at a singular threshold rather than a range, such that when the electric potential is measured above the threshold (or below depending on the need), WE2 is activated and when the electric potential is measured at or below the threshold (or above depending on the need), WE2 is deactivated. As illustrated in FIG. 9 the electric potential of the fueled molten salt may increase as uranium(IV) ions contact WE1 resulting in increased concentration of uranium(III) and may decrease when WE2 is activated and uranium(III) ions are oxidized to uranium(IV) ions resulting in deceased concentration of uranium(III). This processes may be repeated to keep the uranium(IV) to uranium(III) ratio within a predetermined range and may be configured to avoid corrosion to the core of the molten salt reactor system. The second control system may include a means to set and/or adjust the predetermined range.

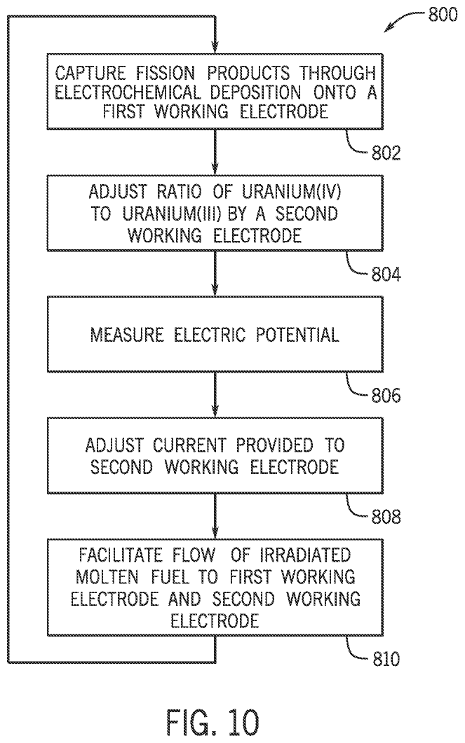

FIG. 10 illustrates a flow diagram of a method 800 for capturing fission products from irradiated fueled molten salt of a molten salt reactor. The steps associated with method 800 may be carried out by the components illustrated in FIG. 8. At step 802, fission products may be captured through electrochemical deposition onto a first working electrode. The electrochemical deposition occurring at step 802 may be promoted by WE1 502 of FIG. 4. This step may include molybdenum cations contacting the first working electrode, prompting reduction of said molybdenum cations, where they are deposited onto the first working electrode (e.g., WE1 502 of FIG. 4) as metallic molybdenum (e.g., Mo⁰ or a molybdenum carbide). At step 804, the ratio of uranium(IV) to uranium(III) ions may be adjusted by the second working electrode. The ratio adjustment of step 804 may be facilitated by WE2 508 of FIG. 4 oxidizing uranium(III) ions on contact. Step 804 may include activating the second working electrode (e.g., WE2 508 of FIG. 4), such that uranium(III) ions are oxidized to uranium(IV) ions, upon contact with the second working electrode. At step 806, the electric potential of the fueled molten salt may be measured. The measurement occurring at step 806 may be facilitated by the third electrode set 604 of FIG. 4. Step 806 may include utilizing the third electrode set (e.g., the third electrode set 604 of FIG. 4) to measure the electric potential of the fueled molten salt. At step 808, the current provided to the second working electrode may be adjusted in response to the measurement received at step 806. The current adjustment at step 808 may be facilitated by the second potentiostat 612 of FIG. 4. Step 806 may include the potentiostat of the second electrode set (e.g., potentiostat 612 of FIG. 4) determining whether the electric potential of the fueled molten salt, measured by the meter of the third electrode set (e.g., meter 614 of FIG. 4), is outside of a predetermined desired potential range. Where the potential is outside of the predetermined range, the second working electrode may be provided with sufficient current in order to activate the electrode (e.g., WE2 508 of FIG. 4). Where the potential is determined to be within the predetermined range, the second working electrode may not be provided current and is either deactivated or remains unactive. Where the potential is outside of the predetermined range, the second working electrode may be provided a variable amount of current to provide a variable reaction rate (i.e., uranium oxidation). At step 810, the conduit may facilitate flow of the fueled molten salt to the first working electrode and second working electrode. Step 810 may include the conduit illustrated in FIGS. 3A-4C comprising piping 312a, 402a, 402b, and 402c. This step may include diverting the molten salt flow through the extraction system (e.g., extraction system 400 of FIG. 4) and back into the molten salt reactor system (e.g., system 300 of FIG. 3A or system 100 of FIG. 1. Following step 810, the process may continue back to step 802.

### Systems

In one embodiment, a system for extraction of reduced fission products from an irradiated fueled molten salt composition comprises:
(i) an irradiated fueled molten salt composition comprising one or more types of molten salts, one or more types of uranium fluoride compounds and fission products in fluid communication with the reactor core of a molten salt reactor;
(ii) a conduit, which comprises an inlet for entry the fueled molten salt composition after reaction in the reactor core of the molten salt reactor, an outlet for return of the fueled molten salt composition to the reactor core of the molten salt reactor, two openings in the wall of the conduit at which counter electrode chambers are attached, and optionally, one or more opening additional opening sealed with a cover for removal of one or more working electrodes;
(iii) a first counter electrode chamber, which protrudes from, or is attached to, the conduit and forms a continuous interior with the conduit;
(iv) a first porous membrane, which forms a cross-sectional permeable barrier between the interior of the first counter electrode chamber and the interior of the conduit;
(v) a first set of electrodes, comprising a first reference electrode and a first working electrode, both in the interior of the conduit, and a first counter electrode in the interior of the first counter electrode chamber and separated from the interior of the conduit by the first porous membrane, wherein the first set of electrodes is in communication with a first control system (e.g., a first potentiostat), which is external to the conduit;
(vi) a second counter electrode chamber, which protrudes from, or is attached to, the conduit and forms a continuous interior with the conduit;
(vii) a second porous membrane, which forms a cross-sectional permeable barrier between the interior of the first counter electrode chamber and the interior of the conduit;
(viii) a second set of electrodes positioned downstream from the first set of electrodes, comprising a second reference electrode and a second working electrode, both in the interior of the conduit, and a second counter electrode in the interior of the second counter electrode chamber and separated from the interior of the conduit by the second porous membrane, wherein the second set of electrodes is in communication with a second control system (e.g., a second potentiostat), which is external to the conduit;
(ix) a third set of electrodes positioned downstream from the second set of electrodes, comprising a third reference electrode and a third working electrode, both in the interior of the conduit, wherein the third set of electrodes is in communication with a meter to measure the uranium ions (e.g. uranium(IV)/(III) balance) in the fueled molten salt composition, wherein the meter is external to the conduit and is in communication with the second control system;
wherein the irradiated fueled molten salt composition exiting the reactor core is at a temperature in the range of about 600° C. to about 700° C.;
wherein the first and second counter electrode chambers each contain an unfueled molten salt composition;
wherein all of the electrodes are in contact with the irradiated fueled molten salt composition or the unfueled molten salt compositions;
wherein the control systems are configured to apply an electric potential to the electrodes to effect reduction of fission products at the first working electrode, deposition of reduced fission products on the first working electrode, and oxidation of uranium(III) at the second working electrode; and
wherein the first working electrode can be removed from the system to facilitate collection of the deposited reduced fission products.

In certain embodiments, the system may comprise one or more additional sets of electrodes, wherein each electrode set comprises a working electrode, a reference electrode and a counter electrode. Additional electrode sets may require additional counter electrode chambers and porous membranes for housing the counter electrodes.

### Methods

Methods for extraction of reduced fission products from an irradiated fueled molten salt composition are provided. The methods are designed for use with and protection of molten salt reactors. The methods are suitable for use with irradiated fueled molten salt composition provided directly from a molten salt reactor core. The methods prepare the irradiated fueled molten salt compositions for return to the molten salt reactor core after extraction. In particular, the methods comprise the step of contacting the irradiated fueled molten salt composition with at least one working electrode which oxidizes uranium(III) to uranium(IV). Restoring the balance of the uranium(IV)/(III) protects the reactor core.

In one embodiment, a method for extraction of reduced fission products from an irradiated fueled molten salt composition comprises:
(i) treating an irradiated fueled molten salt composition with a system according to the embodiments to deposit (e.g., electroplate or electrodeposit) reduced fission products on one or more electrodes (e.g., working electrodes);
(ii) collecting the reduced fission products from the one or more electrodes;
wherein the irradiated fueled molten salt composition comprises one or more types of molten salts, one or more types of uranium fluoride compounds and fission products in fluid communication with a reactor core of a molten salt reactor.

In certain embodiments, the reduced fission products are deposited on and collected from a first working electrode.

In certain embodiments, the method further comprises the step of (iii) returning the irradiated fuel salt composition to the reactor core after treatment with the system.

In one embodiment, a method for separation of reduced fission products from an irradiated fueled molten salt composition comprises:
(a) contacting an irradiated fueled molten salt composition with a first working electrode to reduce fission products which are deposited on the first working electrode;
(b) contacting the irradiated fueled molten salt composition with a second working electrode, after contact with the first working electrode, to oxidize uranium(III) to uranium(IV) compounds contained in the irradiated fueled molten salt composition; and
(c) contacting the irradiated fueled molten salt composition with a third working electrode and measuring the uranium(IV)/(III) ratio of the irradiated fueled molten salt composition with a meter, after contact with the second working electrode;
wherein the irradiated fueled molten salt composition comprises one or more types of molten salts, one or more types of uranium fluoride compounds and fission products in fluid communication with the reactor core of a molten salt reactor.

In one embodiment, a method for extraction of reduced fission products from an irradiated fueled molten salt composition comprises:
(a) contacting an irradiated fueled molten salt composition with a first working electrode to reduce fission products which are deposited on the first working electrode;
(b) contacting the irradiated fueled molten salt composition with a second working electrode, after contact with the first working electrode, to oxidize uranium(III) to uranium(IV) compounds contained in the irradiated fueled molten salt composition;
(c) contacting the irradiated fueled molten salt composition with a third working electrode and measuring the uranium(IV)/(III) ratio of the irradiated fueled molten salt composition with a meter, after contact with the second working electrode; and
(d) collecting the reduced fission products deposited on the first working electrode.
wherein the irradiated fueled molten salt composition comprises one or more types of molten salts, one or more types of uranium fluoride compounds and fission products in fluid communication with the reactor core of a molten salt reactor.

Generally, the temperature of the irradiated fueled molten salt composition provided from the reactor core in the range of about 600° C. to about 700° C.

### Fueled Molten Salt Compositions

The systems and methods according to the embodiments comprise a fueled molten salt composition which comprise one or more molten salts, e.g., molten fluoride salts; and uranium (U-235) fluorides or uranium (U-235) chlorides. In certain embodiments, the fueled molten salt composition comprises uranium (U-235) fluorides. In certain embodiments, the fueled molten salt composition comprises uranium (U-235) chlorides. Typically, the uranium is dissolved in the molten salts at the operational temperature of the system. In certain embodiments, the operational temperature of the fueled molten salt composition is in the range about 600° C. to about 700° C.

In certain embodiments, after undergoing fission reactions in the reactor core of a molten salt reactor, the irradiated fueled molten salt composition comprises one or more types of molten salts, one or more types of uranium fluoride compounds and fission products. In certain embodiments, after undergoing fission reactions in the reactor core of a molten salt reactor, the irradiated fueled molten salt composition comprises one or more types of molten salts, one or more types of uranium chloride compounds and fission products.

In one embodiment, the fueled molten salt composition comprises uranium tetrafluoride (UF₄). In certain embodiments, the fueled molten salt compositions comprises about 1 to about 10 mole % UF₄, about 3 to about 7 mole % UF₄, or about 5 mole % UF₄. In certain embodiments, the uranium tetrafluoride is dissolved in the one or more molten salts. In one embodiment, system comprises molten fluoride salt with uranium tetrafluoride dissolved in the salt.

In one embodiment, the fueled molten salt composition comprises uranium tetrachloride (UCl₄). In certain embodiments, the fueled molten salt compositions comprises about 1 to about 10 mole % UCl₄, about 3 to about 7 mole % UCl₄, or about 5 mole % UCl₄. In certain embodiments, the uranium tetrachloride is dissolved in the one or more molten salts. In one embodiment, system comprises molten fluoride salt with uranium tetrachloride dissolved in the salt.

In certain embodiments, the uranium may be low-enriched uranium, unenriched uranium, or enriched uranium. In one embodiment, the uranium is enriched in ²³⁵U, for example, ²³⁵U enrichment of about 3 to about 25 weight percent (wt %), about 15 to about 25 wt %, about 18 to about 21 wt %, or about 19.75 wt %.

In certain embodiments, the operational density of the fueled molten salt composition is about 1.8 to about 2.8 g/cm³, about 2.0 to about 2.65 g/cm³, about 1.8 to about 2.2 g/cm³, or about 2.4 to about 2.8 g/cm³, about 2.0 g/cm³, about 2.65 g/cm³, or about 2.645 g/cm³.

In certain embodiments, the one or more molten salts comprise lithium fluoride and/or beryllium fluoride. In certain embodiments, the one or more molten salts comprise sodium fluoride.

In one embodiment, the one or more molten salts comprise lithium fluoride (LiF). In certain embodiments, the one or more molten salts comprise about 40 to about 90 mole % LiF, about 60 to about 75 mole % LiF, about 65 to about 70 mole % LiF, or about 67 mole % LiF. In one embodiment, the lithium (e.g., in the LiF-containing molten salt) is enriched in ⁷Li, for example, ⁷Li enrichment of about 90 to about 99.99 wt/o, about 98 to about 99.99 wt %, or about 99.99 wt %.

In one embodiment, the one or more molten salts comprise sodium fluoride (NaF). In certain embodiments, the one or more molten salts comprise about 40 to about 90 mole % NaF, about 60 to about 75 mole % NaF, about 65 to about 70 mole % NaF, or about 67 mole % NaF.

In one embodiment, the one or more molten salts comprise beryllium fluoride (BeF₂). In certain embodiments, the one or more molten salts comprise about 15 to about 50 mole % BeF₂, about 20 to about 40 mole % BeF₂, about 25 to about 30 mole % BeF₂, about 30 to about 35 mole % BeF₂, about 28 mole % BeF₂, or about 33 mole % BeF₂.

In one embodiment, the fueled molten salt composition (e.g., nominal fueled molten salt composition) is LiF—BeF₂—UF₄. In one embodiment, the fueled molten salt composition comprises or consists essentially of LiF, BeF₂ and UF₄. In one embodiment, the fueled molten salt composition (e.g., nominal fueled molten salt composition) is about 67 mole percent % LiF, about 28 mole % BeF₂, and about 5 mole % UF₄.

In one embodiment, the fueled molten salt composition (e.g., nominal fueled molten salt composition) is LiF—BeF₂. In one embodiment, the fueled molten salt composition comprises or consists essentially of LiF and BeF₂. In one embodiment, the fueled molten salt composition (e.g., nominal fueled molten salt composition) is about 67 mole percent % LiF and about 33 mole % BeF₂.

In one embodiment, the fueled molten salt composition (e.g., nominal fueled molten salt composition) is NaF—BeF₂—UF₄. In one embodiment, the fueled molten salt composition comprises or consists essentially of NaF, BeF₂ and UF₄. In one embodiment, the fueled molten salt composition (e.g., nominal fueled molten salt composition) is about 67 mole percent % NaF, about 28 mole % BeF₂, and about 5 mole % UF₄.

In one embodiment, the fueled molten salt composition (e.g., nominal fueled molten salt composition) is NaF—BeF₂. In one embodiment, the fueled molten salt composition comprises or consists essentially of NaF and BeF₂. In one embodiment, the fueled molten salt composition (e.g., nominal fueled molten salt composition) is about 67 mole percent % NaF and about 33 mole % BeF₂.

### Fission Products

Irradiation of the fueled molten salt composition comprising one or more fuel salts and uranium (U-235) fluorides, produces fission products from the uranium fluorides, which are contained in the fueled molten salt composition. In molten salt reactors, fission occurs in the reactor core. After irradiation, a complex mixture of fission products is contained in the fueled molten salt composition. Nonvolatile fission products comprising Ruthenium (Rb), Strontium (Sr), Yttrium (Y), Zirconium (Zr), Scandium (Sc), Barium (Ba), Lanthanum (La), Cerium (Ce), Niobium (Nb), Molybdenum (Mo), Technetium (Tc), Ruthenium (Ru), Rhodium (Rh), Palladium (Pd), Silver (Ag), Antimony (Sb), Tellurium (Te) and Iodine (I) may be present in the irradiated molten fueled salt composition. Among these U-235 fission products, the radioactive isotope Molybdenum-99 is of particular interest because radioactive decay thereof with a radioactive half-life of 66 hours, results in the isotope Technetium-99m which is used in medical diagnostics and which itself has a half-life of 6 hours. In certain embodiments, the fission products comprise molybdenum compounds. In certain embodiments, the fission products comprise molybdenum compounds Mo-99.

### Conduit

In one embodiment the conduit is a series of pipes (e.g., round in cross-section) which includes an inlet on one end and an outlet on the other end, both of which are in fluid communication with piping of a molten salt reactor system. While preferably the conduit of the extraction system is positioned in close proximity to the reactor core of the molten salt reactor, the conduit may be placed at any point in the molten salt reactor system where irradiated fueled molten salt flows. Valves may be positioned on both ends of the conduit to allow for isolation of the conduit system when necessary. The conduit comprises two openings in the wall of the pipe at which the counter electrode chambers are attached and separated by porous membranes. Gastight seals are formed between the conduit and the counter electrode chambers.

The conduit can be formed from any suitable material materials that are stable at the operational temperature and are not reactive with the fueled molten salt compositions. Typically, the conduit is formed from stainless steel, e.g., SS 316H. The conduit can be any suitable length which contains the three sets of electrodes. The walls of the conduit can be any suitable thickness, for example about 1 to about 3 cm.

The conduit may comprise additional openings which are sealed with covers for facilitating removal of one or more working electrodes. Similarly, the conduit may include a plurality of flanges to enable access to the electrodes of the extraction system for replacement, maintenance, etc.

### Working Electrode

Generally, the working electrodes can be any size or shape that fits inside of the conduit and allows passage of the fueled molten salt composition. In certain embodiments, the working electrode is shaped to substantially fill a cross-section of the conduit while not completely blocking the flow of the fueled molten salt composition through the conduit. In certain embodiments, the working electrode is shaped to create a narrow flow of the fueled molten salt around the working electrode. In certain embodiments, the working electrode comprises a mesh portion.

In certain embodiments, the first working electrode is larger than the second working electrode. In certain embodiments, the first working electrode is smaller than the second working electrode. In certain embodiments, the first working electrode is the same size as the second working electrode. In certain embodiments, the first working electrode and/or second working electrode are larger than the third working electrode.

The working electrode can be formed from any suitable materials that are stable at the operational temperature and are not reactive with the fueled molten salt compositions in the absence of an electric potential. In certain embodiments, the one or more working electrodes comprises molybdenum, tungsten, platinum, uranium, any combination thereof, or any suitable electrode material known in the art.

The electric potential of the working electrode is adjusted to optimize deposition of the desired reduced fission products, e.g. Mo-99, and/or to optimize the balance of uranium(IV)/(III) in the irradiated fueled molten salt, e.g. that which is returning to the reactor core. In certain embodiments, the electric potential of each working electrode in the system is the same or different.

In certain embodiments, the electric potential of the first working electrode is a value which facilitates reaction with fission products. In certain embodiments, the electric potential of the first working electrode is a value which promotes deposition of reduced fission products, such as Mo-99. In certain embodiments, the electric potential of the first working electrode if a value that promotes reduction of positively charged molybdenum ions. In certain embodiments, the electric potential of the first working electrode is greater than the voltage at which uranium(IV) is reduced to uranium(III) and lower than the voltage at which Mo(III) or Mo(VI) is reduced to Mo(0) in the fueled molten salt composition. In certain embodiments, the electric potential of the first working electrode is in the range of about −1.15V to about 0 V vs a HF/H₂ reference electrode, or about −0.6 V.

In certain embodiments, the electric potential of the second working electrode is a value which facilitates oxidation of uranium(III) to uranium(IV). In certain embodiments, the electric potential of the second working electrode is less than the voltage at which uranium(III) is oxidized to uranium(IV) in the fueled molten salt composition. In certain embodiments, the electric potential of the second working electrode is in the range of about −1.7V to about −1.16 V vs a HF/H₂ reference electrode, or about −1.4 V. In certain embodiments, the second working electrode can be used to facilitate the oxidation of uranium(III) to uranium(IV) and the electric potential of the second working electrode is greater than the voltage at which uranium(IV) is reduced to uranium(III).

In certain embodiments, the electric potential of the third working electrode is determined by the fueled molten salt composition and a separate potential is not applied to it.

In certain embodiments, the working electrodes can be removed from the conduit, for example, through an opening in the conduit wall which is sealed with a flange. In certain embodiments, one or more working electrodes, e.g. the first working electrode, can be removed for collection of the deposits of reduced fission products, e.g., Mo-99. Following removal of the first working electrode, deposited metallic fission products (e.g., molybdenum) are isolated and purified utilizing known methods.

### Reference Electrode

Each reference electrode is positioned inside the conduit near a working electrode and is in contact with the fueled molten salt composition. In one embodiment, the working electrodes are downstream of their respective reference electrodes. In one embodiment, the working electrodes are upstream of their respective reference electrodes. In one embodiment, the working electrodes are on the same plane to their respective reference electrodes, such that the flow of molten salt contacts them at substantially the same time. The reference electrode can be formed from any suitable materials that are stable at the operational temperature and are not reactive with the fueled molten salt compositions in the absence of an electric potential. The reference electrode must be inert. In certain embodiments, the reference electrode has a surface area comparable to, smaller than, or larger than the first or second working electrode. In certain embodiments, each reference electrode is a silver-silver-fluoride (Ag/AgF) electrode. In certain embodiments, each reference electrode is dynamic reference electrode, for example a dynamic beryllium reference electrode.

### Counter Electrode

Each counter electrode is positioned inside of a counter electrode chamber and is in contact with an unfueled molten salt composition (i.e., molten salt that has not been irradiated by a core of the molten salt reactor system). In one embodiment, the molten salt composition in contact with the counter electrode has passed through the porous membrane and is substantially unfueled. In another embodiment, the unfueled molten salt composition in contact with the counter electrode is unmixed with the irradiated fueled molten salt of the conduit and has been added to the chamber through a separate means (e.g., a port).

Generally, the counter electrodes can be any size or shape that fits inside of the counter electrode chamber and allows contact with the unfueled molten salt composition.

The counter electrode can be formed from any suitable materials that are stable at the operational temperature and are not reactive with the fueled molten salt compositions or unfueled molten salt composition in the absence of an electric potential. In certain embodiments, the one or more counter electrodes comprises molybdenum. In certain embodiments, the one or more counter electrodes comprises tungsten. In certain embodiments, the one or more counter electrodes comprises platinum. In certain embodiments, the one or more counter electrodes comprises uranium.

### Counter Electrode Chamber

Each counter electrode chamber is a vessel which contains one counter electrode and is connected to the conduit. The conduit includes an opening at the site of connection with each counter electrode chamber, which can be any suitable size or shape to allow electric communication between the working electrode and the counter electrode. The counter electrode chamber includes an opening or port at one end for addition or removal of unfueled molten salt. Each counter electrode chamber is connected to the conduit in a position such that an opening of the conduit aligns with the opening of a counter electrode chamber. However, this opening includes a porous membrane to slow or eliminate mixing of molten salt. The counter electrode chamber contains an unfueled molten salt composition. The counter electrode chamber comprises an external port for the addition on the unfueled molten salt composition. The electric communication between counter electrode chamber and the conduit can be accomplished by any suitable means that creates a seal between the counter electrode chamber and the conduit while allowing electrical flow between the irradiated fueled molten salt composition in the conduit and the unfueled molten salt composition in the counter electrode chamber.

A porous membrane is attached to the interior of the counter electrode chamber so as to provide an electrically-permeable barrier between the interior of the conduit and the interior of the counter electrode chamber. This electrically-permeable barrier facilitates electrolysis. In certain embodiments, the porous membrane is situated at the opening of the counter electrode chamber near or close to where the counter electrode chamber meets the conduit. In certain embodiments, the porous membrane is positioned in the counter electrode chamber at any suitable location such that mixing of the molten salt compositions on either side of the porous membrane is minimal or eliminated.

### Porous Membrane

The porous membrane can be any size or shape the fills a cross-section of the counter electrode chamber so as to create a barrier between the unfueled salt composition in the counter electrode chamber and fueled molten salt composition in the conduit. In certain embodiments, the average pore size of the porous membrane is configured to optimize the interaction of the electrodes and to minimize mixing of the fueled and unfueled molten salt compositions. In certain embodiments, the average pores of the porous membrane can be in the range of about 0.1 nm to about 1 mm, or about 0.001 mm to about 1 mm. The total area of pores in the porous membrane is proportional to the surface area of the membrane, for example about 0.1:1 to about 0.5:1 total area of pores to surface area of the membrane.

The material of the porous membrane can be any material suitable for use at temperatures in the range of about 600° C. to about 700° C. In certain embodiments, the porous membrane can be formed from one or more types of metal, for example nickel or stainless steel.

### Uranium(IV)/(III) Balance

Generally, the irradiated fueled molten salt composition exiting the reactor core and entering the conduit of the exemplary system has a ratio of uranium(IV) to uranium(III) of less than about 1000, or in the range of about 10 to about 100. As the uranium(IV) compounds contact the first working electrode, they can be reduced to uranium(III). If the irradiated fueled salt compositions, after treatment with the first working electrode, were returned to the reactor core, the additional uranium(III) would react with graphite in the reactor core to form uranium carbides, which is an undesirable reaction that degrades the reactor core. The exemplary systems and methods employ the second set of electrodes (and optionally, additional sets of electrodes) to oxidize uranium(III) to uranium(IV), thereby restoring the uranium(IV)/(III) ratio to a value at or about that of the irradiated fueled molten salt composition entering the conduit of the exemplary system.

### Molten Salt Reactors

The reactivity of the moderated fuel salt composition can be affected by the following: system pressure and corresponding void fraction (e.g., gas bubbles), fuel salt composition accounting for addition and depletion of UF₄, control rod position, flow of delayed neutrons out of and into the core, temperature effects, and power profile. Operational control is provided by the use of control rods. Reactor shutdown is accomplished by draining the fuel salt composition out of the reactor vessel. In certain embodiments, the reactor core system operates at a maximum temperature of about 700° C.

As part of a molten salt reactor or molten salt research reactor, reactor core systems according to the embodiments are part of a reactor loop, which comprises the reactor core system, Reactor Access Vessel (RAV), reactor pump, and heat exchanger. The fuel salt composition is mobile throughout the reactor core system and the reactor. In certain embodiments, the fuel salt composition exiting the reactor core system (or reactor vessel) flows into the RAV, circulated by the reactor pump. After the reactor pump, the fuel salt is pushed into the heat exchanger and then back to the reactor core system (reactor vessel) through the cold leg of the reactor loop.

In certain embodiments, the Reactor Protection System (RPS) uses a drain tank connected to the cold leg from the heat exchanger to the reactor core system (reactor vessel). The drain tank also has a separate, redundant, direct connection to the reactor vessel. Equalization of the cover gas pressure between the reactor access tank and the drain tank is achieved by opening one of several valves to allow the fuel salt composition to passively drain out of the reactor vessel into the drain tank under the force of gravity. The drain tank is designed to hold the fuel salt composition in a highly subcritical configuration with passive cooling.

Control Rods (CRs), located in the reactor vessel, provide reactivity control during normal operations. The CRs are not credited in any accident analysis. The drain tank also connects to the fuel handling and gas management systems.

The molten salt reactor or molten salt research reactor further comprises a neutron startup source. The neutron source type, strength, and location depend on the neutron detectors chosen and source placement.

The molten salt reactor or molten salt research reactor is surrounded by a thick insulating jacket and internal shield.

In certain embodiments, the molten salt reactor or molten salt research reactor includes a system designed to reflect leakage neutrons back into the core region.

In certain embodiments, the molten salt reactor or molten salt research reactor does not include a system designed to reflect leakage neutrons back into the core region.

In one embodiment, the reactor core system is part of a molten salt reactor or molten salt research reactor which is a loop type 1 MWth molten fluoride salt reactor with uranium tetrafluoride dissolved in the salt operating at a maximum temperature of 700° Celsius.

FIG. 11 presents an illustrative potentiostat or analysis device 1800. The schematic representation in FIG. 11 may be substantially analogous to the first potentiostat 610, second potentiostat 612, and/or meter 614 described above with respect to FIGS. 4 and 5. However, FIG. 11 may also more generally represent other types of devices and configurations that may be used to receive a system input signal from components of the plurality of electrode sets of the extraction system in accordance with the embodiments described herein. In this regard, the potentiostat 1800 may include any appropriate hardware (e.g., computing devices, data centers, switches), software (e.g., applications, system programs, engines), network components (e.g., communication paths, interfaces, routers) and the like (not necessarily shown in the interest of clarity) for use m facilitating any appropriate operations disclosed herein.

As shown in FIG. 11, the potentiostat 1800 may include a processing unit or element 1808a operatively connected to computer memory 1812 and computer-read-able media 1816. The processing unit 1808a may be operatively connected to the memory 1812 and computer-readable media 1816 components via an electronic bus or bridge (e.g., such as system bus 1810). The processing unit 1808a may include one or more computer processors or microcontrollers that are configured to perform operations in response to computer-readable instructions. The processing element 1808a may be a central processing unit of the potentiostat 1800. Additionally or alternatively, the processing unit 1808a may be other processors within the device including application specific integrated chips (ASIC) and other microcontroller devices.

The memory 1812 may include a variety of types of non-transitory computer-readable storage media, including, for example, read access memory (RAM), read-only memory (ROM), erasable programmable memory (e.g., EPROM and EEPROM), or flash memory. The memory 1812 is configured to store computer-readable instructions, sensor values, and other persistent software elements. Computer-readable media 1816 may also include a variety of types of non-transitory computer-readable storage media including, for example, a hard-drive storage device, a solid state storage device, a portable magnetic storage device, or other similar device. The computer-readable media 1816 may also be configured to store computer-readable instructions, sensor values, and other persistent software elements.

In this example, the processing unit 1808a is operable to read computer-readable instructions stored on the memory 1812 and/or computer-readable media 1816. The computer-readable instructions may adapt the processing unit 1808a to perform the operations or functions described above with respect to FIGS. 1-10. The computer-readable instructions may be provided as a computer-program product, software application, or the like.

As shown in FIG. 11, the potentiostat 1800 may also include a display 1818. The display 1818 may include a liquid-crystal display (LCD), organic light emitting diode (OLED) display, light emitting diode (LED) display, or the like. The potentiostat 1800 may also include means to connect to a remote display. If the display 1818 is an LCD, the display may also include a backlight component that can be controlled to provide variable levels of display brightness. If the display 1818 is an OLED or LED type display, the brightness of the display 1818 may be controlled by modifying the electrical signals that are provided to display elements.

The potentiostat 1800 may also include a battery 1824 that is configured to provide electrical power to the components of the potentiostat 1800. The battery 1824 may include one or more power storage cells that are linked together to provide an internal supply of electrical power. In this regard, the battery 1824 may be a component of a power source 1828 (e.g., including a charging system or other circuitry that supplies electrical power to components of the potentiostat 1800). The battery 1824 may be operatively coupled to power management circuitry that is configured to provide appropriate voltage and power levels for individual components or groups of components within the potentiostat 1800. The battery 1824, via power management circuitry, may be configured to receive power from an external source, such as an AC power outlet or interconnected computing device. The battery 1824 may store received power so that the potentiostat 1800 may operate without connection to an external power source for an extended period of time, which may range from several hours to several days.

The potentiostat 1800 may also include one or more sensors 1840 that may be used to detect a touch and/or force input, environmental condition, orientation, position, or some other aspect of the potentiostat 1800. In this regard, the sensors 1840 may be used to detect an input at a touch-sensitive display (e.g., display 1818) of the potentiostat 1800 and/or other surface or feature, such as an external surface of the analysis device 1800 defined by an outer enclosure or shell. Additionally, the potentiostat 1800 may include means to functionally communicate with external sensors. Example sensors 1840 that may be included in the potentiostat 1800 may include, without limitation, one or more accelerometers, gyrometers, inclinometers, goniometers, or magnetometers. The sensors 1840 may also include one or more proximity sensors, such as a magnetic hall-effect sensor, inductive sensor, capacitive sensor, continuity sensor, or the like. Resistive and contact-based sensors may also be used.

The sensors 1840 may also be broadly defined to include wireless positioning devices including, without limitation, global positioning system (GPS) circuitry, Wi-Fi circuitry, cellular communication circuitry, and the like. As such, the sensors 1840 may be used to identify an environment of the potentiostat 1800 (e.g., a clinical setting, a service facility, and so on). The potentiostat 1800 may, in some embodiments, execute a different mode or configuration based on the identified environment, such as executing different analysis cycles, testing or calibrating produces, and so on. The potentiostat 1800 may also include one or more optical sensors including, without limitation, photo-detectors, photosensors, image sensors, infrared sensors, or the like. In one example, the sensor 1840 may be an image sensor that detects a degree to which an ambient image matches a stored image. As such, the sensors 1840 may be used to identify a user of the potentiostat 1800. In this regard, the sensors 1840 may be used to control access to the potentiostat 1800, for example, such as by initiating one or more operations when the sensors 1840 identify a known or authenticated user. The sensors 1840 may also include one or more acoustic elements, such as a microphone used alone or in combination with a speaker element. This may allow the potentiostat 1800 to be operable by voice control, among other possibilities. The sensors 1840 may also include a temperature sensor, barometer, pressure sensor, altimeter, moisture sensor or other similar environmental sensor. The sensors 1840 may also include a light sensor that detects an ambient light condition of the potentiostat 1800.

The sensors 1840, either alone or in combination, may generally be a motion sensor that is configured to determine an orientation, position, and/or movement of the potentiostat 1800. For example, the sensors 1840 may include one or more motion sensors including, for example, one or more accelerometers, gyrometers, magnetometers, optical sensors, or the like to detect motion. The sensors 1840 may also be configured to determine one or more environmental conditions, such as temperature, air pressure, humidity, and so on. The sensors 1840, either alone or in combination with other input, may be configured to estimate a property of a supporting surface including, without limitation, a material property, surface property, friction property, or the like.

The potentiostat 1800 may also include a camera 1832 that is configured to capture a digital image or other optical data. The camera 1832 may include a charge-coupled device, complementary metal oxide (CMOS) device, or other device configured to convert light into electrical signals. The camera 1832 may also include one or more light sources, such as a strobe, flash, or other light-emitting device. As discussed above, the camera 1832 may be generally categorized as a sensor for detecting optical conditions and/or objects in the proximity of the potentiostat 1800. However, the camera 1832 may also be used to create photorealistic images that may be stored in an electronic format, such as JPG, GIF, TIFF, PNG, raw image file, or other similar file types. In a sample embodiment, the camera 1832 may be used to capture an image of an authenticated user of the potentiostat 1800. The photorealistic image captured by the camera 1832 may be stored (e.g., at memory 1812 and/or an external source). The sensors 1840, as described above, may be used to compare an ambient image (e.g., a user requesting access) with the stored imaged. Where the images sufficiently match, the potentiostat 1800 may allow the requesting user to initiate one or more operations (e.g., testing a breath sample). This may be helpful in clinical settings, for example, in which may be desirable to limit physical contact with the potentiostat 1800.

The potentiostat 1800 may also include a communication port 1844 that is configured to transmit and/or receive signals or electrical communication from an external or separate device. The communication port 1844 may be configured to couple to an external device via a cable, adaptor, or other type of electrical connector. In some embodiments, the communication port 1844 may be used to couple the potentiostat 1800 with a computing device and/or other appropriate accessories configured to send and/or receive electrical signals. The communication port 1844 may be configured to receive identifying information from an external accessory, which may be used to determine a mounting or support configuration. For example, the communication port 1844 may be used to determine that the potentiostat 1800 is coupled to a mounting accessory, such as a particular type of stand or support structure.

Additionally, the potentiostat 1800 may be an electronic hardware device and generally operable to control a three-electrode cell or three electrode circuit and run electroanalytical experiments. The potentiostat 1800 may be a bipotentiostat capable of controlling two working electrodes or a polypotentiostat capable of controlling two or more working electrodes. The potentiostat 1800 may be configured to maintain the potential of a working electrode (e.g., WE1 502 or WE2 508 of FIG. 4) at a constant level with respect to a reference electrode (e.g., RE1 500, RE2 506, or RE3 510 of FIG. 4) by adjusting the current at an auxiliary electrode.

Although embodiments described herein are made with reference to example embodiments, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

### EXAMPLES

### Example 1. Demonstration of Properties in Aqueous System

Exemplary systems and methods can be initially tested and optimized in aqueous fluids, rather than molten salt compositions. A composition of water, ferricyanide and Cu(II) can be used to demonstrate the systems and methods useful for uranium and Mo-99. Similar to the fission products in the exemplary molten salt systems, Cu(II) is reduced to Cu(0) at the first working electrode and deposited thereon. Ferricyanide may be reduced at the first electrode to form ferrocyanide, similar to the uranium(IV) being reduced to uranium(III) in the exemplary molten salt systems. Ferrocyanide will be oxidized by the second electrode to produce ferricyanide, adjusting ratio of ferricyanide and ferrocyanide as desired.

We claim:

1. A system for capture of fission products from irradiated fueled molten salt of a molten salt reactor system comprising:
a first electrode circuit comprising a first working electrode, the first electrode circuit operable to capture the fission products from the irradiated fueled molten salt by electrochemical deposition of the fission products onto the first working electrode;
a second electrode circuit comprising a second working electrode and a potentiostat, the second electrode circuit operable to adjust a ratio of uranium(IV) to uranium(III) of the irradiated fueled molten salt by oxidation of uranium(III) by the second working electrode;
a third electrode circuit comprising a meter electrically coupled with the potentiostat operable to measure an electric potential of the irradiated fueled molten salt;
wherein the potentiostat is operable to adjust an electric current provided to the second working electrode upon the meter reading that the electric potential of the irradiated fueled molten salt has reached a predetermined threshold; and
wherein the first electrode circuit, second electrode circuit, and third electrode circuit are housed in a conduit of the molten salt reactor system.

2. The system of claim 1, wherein the conduit is configured to facilitate flow of the irradiated fueled molten salt of the molten salt reactor system to the first working electrode, the second working electrode, and the third electrode circuit.

3. The system of claim 1, wherein the first electrode circuit includes a first counter electrode enclosed in a first counter electrode chamber, which protrudes from and/or is attached to the conduit, such that the first counter electrode chamber is along a different fluid path than a fluid path of the conduit.

4. The system of claim 3, wherein the first counter electrode chamber is separate from an interior of the conduit by a first porous membrane.

5. The system of claim 3, wherein the first counter electrode chamber contains unfueled molten salt.

6. The system of claim 5, wherein the first porous membrane is operable to provide an electrically permeable barrier between the irradiated fueled molten salt of the conduit and the unfueled molten salt of the first counter electrode chamber, and wherein the electrically permeable barrier is operable to minimize and/or prevent mixing of the irradiated fueled molten salt and the unfueled molten salt while allowing passage of current.

7. The system of claim 4, wherein the first porous membrane comprises a plurality of pores with a size of about 0.1 nanometer to about 1 millimeter.

8. The system of claim 1, wherein the first electrode circuit, second electrode circuit, and third electrode circuit are located within the conduit such that the third electrode circuit is positioned downstream of the second electrode circuit and the second electrode circuit is positioned downstream of the first electrode circuit.

9. The system of claim 1, wherein the fission products comprises molybdenum-99.

10. The system of claim 1, wherein the first working electrode is removable from the first electrode circuit.

11. The system of claim 5, wherein the first working electrode is operable to reduce the fission products and the first counter electrode is operable to oxidize the unfueled molten salt.

12. The system of claim 1, wherein the conduit includes an inlet in fluid communication with a core of the molten salt reactor, such that the first electrode circuit is positioned proximal to an outlet of a molten salt reactor vessel of the molten salt reactor system.

13. The system of claim 1, wherein the conduit includes at least one bypass valve and at least one bypass pipe operable to divert the flow of irradiated fueled molten salt to the first working electrode in the at least one bypass pipe.

14. A system comprising:
a fuel salt system configured to circulate an irradiated fueled molten salt through a molten salt loop, the molten salt loop including a reactor vessel; and
an extraction system fluidly coupled to the reactor vessel along the molten salt loop, the extraction system, comprising
a first electrode circuit comprising a first working electrode, the first electrode circuit operable to capture the fission products from the irradiated fueled molten salt by electrochemical deposition of the fission products onto the first working electrode;
a second electrode circuit comprising a second working electrode and a potentiostat, the second electrode circuit operable to adjust a ratio of uranium(IV) to uranium(III) of the irradiated fueled molten salt by oxidation of uranium(III) by the second working electrode;
a third electrode circuit comprising a meter electrically coupled with the potentiostat operable to measure an electric potential of the irradiated fueled molten salt;
wherein the potentiostat is operable to adjust an electric current provided to the second working electrode upon the meter of the third electrode circuit reading that the electric potential of the irradiated fueled molten salt has reached a predetermined threshold; and
wherein the first electrode circuit, second electrode circuit, and third electrode circuit are housed in a conduit of the molten salt loop.

15. The system of claim 14, further comprising a reactor pump fluidly coupled to the extraction system operable to facilitate the circulation of the irradiated fueled molten salt to the extraction system.

16. The system of claim 14, further comprising a heat exchanger positioned within the molten salt loop, such that the heat exchanger is downstream of the reactor pump, the reactor pumped is downstream of the extraction system, and the extraction system is downstream of the reactor vessel.

17. The system of claim 14, wherein the second electrode circuit includes a second counter electrode encased in a second counter electrode chamber, which protrudes from and/or is attached to the conduit; wherein the second counter electrode chamber contains unfueled molten salt; and wherein the second counter electrode chamber is separated from an interior of the conduit by a second porous membrane operable to provide an electrically permeable barrier between the irradiated molten salt and the unfueled molten salt.

18. The system of claim 17, wherein the first counter electrode chamber and the second counter electrode chamber are fluidly connected by a channel.

19. The system of claim 14, wherein the first working electrode is removable from the first electrode circuit.

20. A method for capturing fission products from irradiated fueled molten salt of a molten salt reactor comprising:
capturing the fission products from the irradiated fueled molten salt through electrochemical deposition of the fission products onto a first working electrode;
adjusting a ratio of uranium(IV) to uranium(III) of the irradiated fueled molten salt by oxidizing uranium(III) by a second working electrode;
measuring an electric potential of the irradiated fueled molten salt;
adjusting the electric current provided to the second working electrode upon the electric potential of the irradiated fueled molten salt reaching a predetermine threshold; and
facilitating flow of the irradiated fueled molten salt of the molten salt reactor to the first working electrode and the second working electrode by a conduit configured to house the first working electrode and the second working electrode.

21. The method of claim 10, wherein adjusting the electric current provided to the second working electrode includes shutting off the electric current provided to the second working electrode upon the electric potential being above an upper range of the predetermined threshold.

22. The method of claim 20, wherein the fission products comprises molybdenum.

23. The method of claim 20, further comprising isolating the first working electrode from the flow of the irradiated fueled molten salt through at least one bypass of the conduit.

24. The method of claim 23, further comprising removing the first working electrode from the conduit.
